(19) United States
(12) Patent Application Publication
(10) Pub. No.: US 2025/0270872 A1
(43) Pub. Date: Aug. 28, 2025

(54) FENESTRATION UNIT WITH INTERIOR INSTALLATION FEATURES AND ASSOCIATED SYSTEMS AND METHODS

(71) Applicant: Pella Corporation, Pella, IA (US)

(72) Inventors: Jake Baier, Pella, IA (US); Todd A. Bernhagen, Pella, IA (US); Jon Hoogland, Pella, IA (US); Jaime P. Ogbourne, Knoxville, IA (US); Bill R. Parcells, Des Moines, IA (US); Evan Vande Haar, Pella, IA (US)

(73) Assignee: Pella Corporation, Pella, IA (US)

(21) Appl. No.: 19/057,850

(22) Filed: Feb. 19, 2025

Related U.S. Application Data
(60) Provisional application No. 63/557,037, filed on Feb. 23, 2024.

(51) Int. Cl. E06B 1/60

(52) U.S. Cl. CPC E06B 1/6023; E06B 1/6069

(57) ABSTRACT

Installation systems and methods for fenestration units configured to be set into a rough opening from an interior side of a building or wall. The fenestration units may include a retention system coupled to the frame and operable to exert a retention force on the fenestration unit to maintain positive engagement of the fenestration unit with the rough opening framing and resist extraction of the fenestration unit from the rough opening upon insertion of the fenestration unit in the rough opening from the interior side of the rough opening.

### CROSS-REFERENCE TO RELATED APPLICATION

This application claims priority to U.S. Provisional Patent Application No. 63/557,037, entitled “FENESTRATION UNIT WITH INTERIOR INSTALLATION FEATURES AND ASSOCIATED SYSTEMS AND METHODS”, filed Feb. 23, 2024, the disclosure of which is hereby incorporated by reference in its entirety.

### BACKGROUND

Window designs typically have an exterior nailing flange and are installed from the exterior side of the building envelope. Two installers work together, one on the interior and the other on the exterior. Some installation crews have determined it is easier to unpackage the window inside the building where it is relatively clean and flat. Then they pass the window through the rough opening to a person on the exterior side. In some instances, the person on the exterior side is on a ladder which can substantially complicate installation. The installer on the interior side centers the window in the rough opening and inserts shims to level, plumb and square all while the exterior installer is holding the window. After the window is correctly set, the interior installer holds the window in place while the exterior installer drives nails or screws through the exterior nailing flange to anchor it. If it is a venting window, the sash is then opened to check functional operation. The interior installer proceeds to inject expansion foam around the perimeter of the window in the gap between the frame and rough opening to create the interior air seal. At the same time, the exterior installer applies 3 to 4 inches wide flashing tape on the jambs and across the head of the window.

### BACKGROUND PATENTS

| Patent Number | Title | Filing Date |
|---|---|---|
| U.S. Pat. No. 8,621,795 | Fenestration frame with bonded support | 2011 Apr. 20 |
| | brackets . . . | |
| U.S. Pat. No. 8,109,052 | Monolithic fenestration construction | 2009 May 21 |
| | member . . . | |
| U.S. Pat. No. 7,162,841 | Spring clip and method of window | 2004 Feb. 13 |
| | installation | |
| DE 2020 16101375 | Supporting and fastening | 2016 Mar. 11 |
| | window . . . to . . . wall opening | |
| WO 2015/142201 | Mounting, sealing and thermal insulation | 2014 Sep. 5 |
| | of windows . . . | |
| U.S. Pat. No. 6,293,061 | System and method for installing a jamb | 1999 Sep. 30 |
| U.S. Pat. No. 5,692,350 | Apparatus and method for leveling | 1996 Feb. 2 |
| | closures | |
| U.S. Pat. No. 11,332,946 | Installation features for fenestration | 2019 Jul. 25 |
| | units . . . | |
| U.S. Pat. No. 8,006,445 | Self-sealing window installation and | 2008 Jan. 15 |
| | method | |
| U.S. 2008/0127564 | Pre-hung door assembly and method of | 2008 Jan. 18 |
| | installation | |
| U.S. Pat. No. 10,895,099 | Support bracket for window | 2016 Aug. 23 |
| | installation . . . | |
| U.S. 2005/0262782 | Self-Flashing Assembly | 2004 Jun. 1 |
| U.S. 2020/0318418 | Fenestration assembly and installation | 2020 Apr. 2 |
| | system for the same | |
| U.S. Pat. No. 4,488,391 | Centering clips for window frames | 1980 Dec. 17 |
| U.S. 2011/0258947 | Fenestration frame with bonded support | 2011 Apr. 20 |
| | brackets and methods of making same | |

### BACKGROUND PRODUCTS

Innotech Windows & Doors, Strap Anchors
https://www.innotech-windows.com/blog/in-depth-benefits-of-anchoring-method-window-installation
FrontLine Tru-Loc™ Brackets
https://frontlinebldg.com/all-products/accessories/tru-loc-window-door-installation-anchor/
Amesbury Hinged Fin
https://www.amesburytruth.com/products/extrusions/nailing-fin/hinged/hinged-pp1219

### SUMMARY

Various advantages may be achieved according to the example systems and methods described herein. The various examples may be one or more of: more efficient (e.g., cycle time reduced by 50% or more); easier to learn; easier to remember; easier to train; may be less physically demanding (e.g., window is not set from the exterior side which could be on uneven ground or require a ladder); window is unable to fall out toward exterior during installation; can be installed by a single person from the interior of the building or wall; interior and exterior installation tasks do not need to be done simultaneously; improved fenestration install quality and fenestration performance following installation; delivers an installation method that is unique to the industry and offers many benefits for the installer; faster cycle times; improved performance (water and air infiltration); adapts to wall depth variation; simplifies casing installation for finish carpenters; separates interior and exterior work so they can be done “independently”.

### Install Brackets—Device

According to one embodiment (“Embodiment 1”), a fenestration unit is configured for installation in a rough opening in a structure defined by rough opening framing. The rough opening framing has an interior face and an exterior face opposite the interior face. The fenestration unit includes a frame having a channel and a plurality of mounting brackets configured to be secured to the frame. The plurality of mounting brackets include a first mounting bracket, and the first mounting bracket includes a first leg including a foot configured to be received in the channel to secure the first mounting bracket to the frame, and a second leg coupled to the first leg. The second leg is angularly offset from the first leg and configured to abut the interior face of the rough opening framing.

According to another embodiment (“Embodiment 2”), further to Embodiment 1, the frame further includes a sidewall defining the channel, the sidewall including a slot, and the foot being received in the slot.

According to another embodiment (“Embodiment 3”), further to any of Embodiments 1-2, the foot includes an ankle portion coupled to an angled toe portion.

According to another embodiment (“Embodiment 4”), further to any of Embodiments 1-3, the frame further includes a sidewall defining the channel, the sidewall including a slot, and the toe portion being received in the slot.

According to another embodiment (“Embodiment 5”), further to any of Embodiments 1-4, the foot further includes a claw extending from the toe portion.

According to another embodiment (“Embodiment 6”), further to any of Embodiments 1-5, further including an installation stabilizer system coupled to the frame and operable to exert a retention force on the rough opening framing to maintain positive engagement of the fenestration unit with the rough opening framing and resist extraction of the fenestration unit from the rough opening upon insertion of the fenestration unit in the rough opening.

According to another embodiment (“Embodiment 7”), further to any of Embodiments 1-6, the first leg is integrally formed with the second leg.

According to another embodiment (“Embodiment 8”), further to any of Embodiments 1-7, the frame further includes a sill, and further including a sill spacer coupled to the sill and configured to abut the rough opening framing.

According to another embodiment (“Embodiment 9”), further to any of Embodiments 1-8, further including a fin assembly coupled to the frame, the fin assembly configured to transition from a first, stowed configuration in which the fin assembly projects in a direction of a front of the frame and a second, deployed configuration in which the fin assembly projects outward relative to the frame.

According to another embodiment (“Embodiment 10”), further to any of Embodiments 1-9, the frame further includes an exterior surface, an interior surface opposite the exterior surface, and a perimeter between the exterior surface and the interior surface, the channel being disposed on the perimeter.

According to another embodiment (“Embodiment 11”), further to any of Embodiments 1-10, the foot is a first foot and the first leg further includes a second foot configured to be removably received in the channel to secure the first mounting bracket to the frame.

According to another embodiment (“Embodiment 12”), further to any of Embodiments 1-11, the second leg includes an aperture configured to receive a fastener for securing the fenestration unit to the rough opening framing.

According to another embodiment (“Embodiment 13”), further to any of Embodiments 1-12, the frame further includes an exterior surface, an interior surface opposite the exterior surface, and a perimeter between the exterior surface and the interior surface, the channel being disposed on the interior surface.

According to another embodiment (“Embodiment 14”), further to any of Embodiments 1-13, the channel is a first channel, the frame further includes a second channel being disposed on the perimeter, and the first leg further includes a second foot configured to be removably received in the second channel to secure the first mounting bracket to the frame.

According to another embodiment (“Embodiment 15”), further to any of Embodiments 1-14, the first channel is an accessory channel, the second channel is an installation fin channel, and further including an installation fin assembly disposed in the installation fin channel.

According to another embodiment (“Embodiment 16”), further to any of Embodiments 1-15, the second leg includes an aperture configured to receive a fastener for securing the fenestration unit to the rough opening framing.

According to another embodiment (“Embodiment 17”), further to any of Embodiments 1-16, the mounting bracket further includes an installation stabilizer system operable to exert a retention force on the rough opening framing to maintain positive engagement of the fenestration unit with the rough opening framing and resist extraction of the fenestration unit from the rough opening upon insertion of the fenestration unit in the rough opening.

According to another embodiment (“Embodiment 18”), further to any of Embodiments 1-17, the first mounting bracket includes actuator being actuatable to couple the first mounting bracket to the frame.

According to another embodiment (“Embodiment 19”), further to any of Embodiments 1-18, the actuator is actuatable to move the foot into the channel and thereby couple the first mounting bracket to the frame.

According to another embodiment (“Embodiment 20”), further to any of Embodiments 1-19, the actuator includes a pivotable lever.

According to another embodiment (“Embodiment 21”), further to any of Embodiments 1-20, further including a coupling bracket configured to be secured to the frame, wherein the coupling bracket includes an aperture configured to receive a fastener for securing the fenestration unit to the rough opening framing.

### Install Brackets—Method of Installation

According to one embodiment (“Embodiment 1”), a method of installing a fenestration unit in a rough opening in a structure defined by rough opening framing, the rough opening framing having an interior face and an exterior face opposite the interior face, includes: coupling a first mounting bracket to a frame of the fenestration unit by positioning a foot of a first leg of the first mounting bracket in a channel of the frame; seating the fenestration unit in the rough opening by together translating the frame and the first mounting bracket in an exterior direction within the rough opening until a second leg of the first mounting bracket angularly offset from the first leg is abutted against the interior face of the rough opening framing; and securing the fenestration unit to the rough opening framing.

According to another embodiment (“Embodiment 2”), further to Embodiment 1, the frame further includes a sidewall defining the channel, the sidewall including a slot, and positioning the foot of the first mounting bracket in the channel includes positioning the foot in the slot.

According to another embodiment (“Embodiment 3”), further to any of Embodiments 1-2, the foot includes an ankle portion coupled an angled toe portion, and positioning the foot of the first mounting bracket in the channel includes positioning the angled toe portion in the slot.

According to another embodiment (“Embodiment 4”), further to any of Embodiments 1-3, further including forming the slot in the sidewall at a predetermined location on the frame, and thereafter positioning the foot of the first mounting bracket in the slot.

According to another embodiment (“Embodiment 5”), further to any of Embodiments 1-4, forming the slot in the sidewall at the predetermined location on the frame is performed in a manufacturing setting, and positioning the foot of the first mounting bracket in the slot is performed in an installation setting.

According to another embodiment (“Embodiment 6”), further to any of Embodiments 1-5, seating the fenestration unit in the rough opening further includes abutting an installation stabilizer system coupled to the fenestration unit against the rough opening framing such that the installation stabilizer system exerts a retention force on the rough opening framing to retain the fenestration unit in the rough opening and prevent tipping of the fenestration unit in an interior direction opposite the exterior direction.

According to another embodiment (“Embodiment 7”), further to any of Embodiments 1-6, seating the fenestration unit in the rough opening further includes abutting a sill spacer coupled to a bottom of the frame against the rough opening framing.

According to another embodiment (“Embodiment 8”), further to any of Embodiments 1-7, further including deploying a fin assembly coupled to the frame from a first, stowed configuration in which the fin assembly projects in the exterior direction to a second, deployed configuration in which the fin assembly projects outward relative to the frame.

According to another embodiment (“Embodiment 9”), further to any of Embodiments 1-8, the second leg includes an aperture, and wherein securing the fenestration unit to the rough opening framing includes inserting a fastener in the aperture.

According to another embodiment (“Embodiment 10”), further to any of Embodiments 1-9, the frame further includes an exterior surface, an interior surface opposite the exterior surface, and a perimeter between the exterior surface and the interior surface, the channel being disposed on the interior surface.

According to another embodiment (“Embodiment 11”), further to any of Embodiments 1-10, the frame further includes an exterior surface, an interior surface opposite the exterior surface, and a perimeter between the exterior surface and the interior surface, the channel being disposed on the perimeter.

According to another embodiment (“Embodiment 12”), further to any of Embodiments 1-11, seating the fenestration unit in the rough opening further includes abutting an installation stabilizer system coupled to the first mounting bracket against the rough opening framing such that the installation stabilizer system exerts a retention force on the rough opening framing to retain the fenestration unit in the rough opening and prevent tipping of the fenestration unit in an interior direction opposite the exterior direction.

According to another embodiment (“Embodiment 13”), further to any of Embodiments 1-12, securing the fenestration unit to the rough opening framing includes installing a fastener through a coupling bracket coupled to the frame.

According to another embodiment (“Embodiment 14”), further to any of Embodiments 1-13, installing the fastener through the coupling bracket includes installing the fastener through an aperture of the coupling bracket, and further including using the aperture as a centering guide before installing the fastener through the aperture of the coupling bracket.

According to another embodiment (“Embodiment 15”), further to any of Embodiments 1-14, the coupling bracket includes an outer surface having a double taper, and further including positioning a shim between the double taper of the outer surface and the rough opening framing.

According to another embodiment (“Embodiment 16”), further to any of Embodiments 1-15, positioning the shim between the double taper of the outer surface and the rough opening framing includes inserting the shim from above the coupling bracket.

According to another embodiment (“Embodiment 17”), further to any of Embodiments 1-16, inserting the shim from above the coupling bracket includes permitting gravity to move the shim between the double taper of the outer surface and the rough opening framing.

According to another embodiment (“Embodiment 18”), further to any of Embodiments 1-17, securing the fenestration unit to the rough opening framing includes permanently coupling the coupling bracket to the frame via the fastener.

According to another embodiment (“Embodiment 19”), further to any of Embodiments 1-18, further including, after permanently coupling the coupling bracket to the frame via the fastener, detaching the first mounting bracket from the frame.

According to another embodiment (“Embodiment 20”), further to any of Embodiments 1-19, further including, after seating the fenestration unit in the rough opening, abutting the first mounting bracket against the interior face of the rough opening framing, and securing the fenestration unit to the rough opening framing, detaching the first mounting bracket from the frame.

According to another embodiment (“Embodiment 21”), further to any of Embodiments 1-20, the first mounting bracket further includes an actuator, and positioning the foot of the first mounting bracket in the channel of the frame includes actuating the actuator to move the foot relative to the frame.

According to another embodiment (“Embodiment 22”), further to any of Embodiments 1-21, the actuator includes a lever, and actuating the actuator includes pivoting the lever relative to the first leg of the first mounting bracket.

The foregoing embodiments and additional embodiments described herein should not be read to limit or otherwise narrow the scope of any of the inventive concepts otherwise provided by the instant disclosure. While multiple examples are disclosed, still other embodiments will become apparent to those skilled in the art from this specification and its drawings, which show and describe various illustrative examples. Accordingly, the drawings and detailed description are to be regarded as illustrative in nature rather than restrictive in nature.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIG. 1 is a top-oriented perspective view of a fenestration unit and rough opening framing from an interior side, according to some embodiments.

FIG. 2 is a bottom-oriented perspective view of the fenestration unit of FIG. 1 from an exterior side, according to some embodiments.

FIG. 3 is a detail perspective view of the features of the fenestration unit within line 3-3 of FIG. 1, including a mounting bracket, according to some embodiments.

FIG. 4 is a top section view of the fenestration unit taken along line 4-4 of FIG. 3, according to some embodiments.

FIG. 5 is a top-oriented perspective view of the mounting bracket of FIG. 3, according to some embodiments.

FIG. 6 is a bottom-oriented perspective view of the mounting bracket of FIG. 3, according to some embodiments.

FIG. 7 is a detail perspective view of the features of the fenestration unit within line 7-7 of FIG. 1, including a retainer, according to some embodiments.

FIG. 8 is a side section view of the fenestration unit taken along line 8-8 of FIG. 7, according to some embodiments.

FIG. 9 is a top-oriented perspective view of the retainer of FIG. 7, according to some embodiments.

FIG. 10 is a bottom-oriented perspective view of the retainer of FIG. 7, according to some embodiments.

FIG. 11 is a detail perspective view of the features of the fenestration unit within line 11-11 of FIG. 2, including a sill spacer, according to some embodiments.

FIG. 12 is a side section view of the fenestration unit taken along line 12-12 of FIG. 1, according to some embodiments.

FIG. 13 is a top-oriented perspective view of another fenestration unit from an interior side, according to some embodiments.

FIG. 14 is a bottom-oriented perspective view of the fenestration unit of FIG. 13 from an exterior side, according to some embodiments.

FIG. 15 is a detail perspective view of the features of the fenestration unit within line 15-15 of FIG. 13, including a mounting bracket, according to some embodiments.

FIG. 16 is a top section view of the fenestration unit taken along line 16-16 of FIG. 15, according to some embodiments.

FIG. 17 is a top-oriented perspective view of the mounting bracket of FIG. 15, according to some embodiments.

FIG. 18 is a bottom-oriented perspective view of the mounting bracket of FIG. 15, according to some embodiments.

FIG. 19 is a detail perspective view of the features of the fenestration unit within line 19-19 of FIG. 13, including a retainer, according to some embodiments.

FIG. 20 is a side section view of the fenestration unit taken along line 20-20 of FIG. 19, according to some embodiments.

FIG. 21 is a top-oriented perspective view of the retainer of FIG. 19, according to some embodiments.

FIG. 22 is a bottom-oriented perspective view of the retainer of FIG. 19, according to some embodiments.

FIG. 23 is a partial top section view of a frame and a mounting bracket of another fenestration unit, according to some embodiments.

FIG. 24 is a perspective view of the mounting bracket of FIG. 23, according to some embodiments.

FIG. 25 is a top view of a cam of the mounting bracket in a channel of the frame of FIG. 23 and an unlocked configuration, according to some embodiments.

FIG. 26 is a top view of the cam of the mounting bracket in the channel of the frame of FIG. 25 and a locked configuration, according to some embodiments.

FIG. 27 is a top-oriented perspective view of another fenestration unit from an interior side, according to some embodiments.

FIG. 28 is a side section view of yet another fenestration unit, rough opening framing, and an interior wall covering, according to some embodiments.

FIG. 29 is a side section view of a mounting bracket of a fenestration unit, according to some embodiments.

FIG. 30 is a bottom-oriented perspective view of another fenestration unit from an interior side, according to some embodiments.

FIG. 31 is a side section view of the fenestration unit taken along line 31-31 of FIG. 30, according to some embodiments.

FIG. 32 is a bottom-oriented perspective view of another fenestration unit from an interior side, according to some embodiments.

FIG. 33 is a side section view of the fenestration unit taken along line 33-33 of FIG. 32, according to some embodiments.

FIG. 34 is a top perspective view of another fenestration unit from an interior side, according to some embodiments.

FIG. 35 is a bottom perspective view of the fenestration unit of FIG. 34 from the interior side, according to some embodiments.

FIG. 36 is a detail view of features of the fenestration unit within line 36-36 of FIG. 34, including coupling brackets, a mounting bracket, and a retainer, according to some embodiments.

FIG. 37 is a side view of the mounting bracket and the retainer of FIG. 35, according to some embodiments.

FIG. 38 is a perspective view of the mounting bracket of FIG. 35, according to some embodiments.

FIG. 39 is a detail top view of the mounting bracket of FIG. 35 and a frame of the fenestration unit of FIG. 35 with a movable leg of the mounting bracket in a retracted configuration, according to some embodiments.

FIG. 40 is a detail top view of the mounting bracket and the frame of FIG. 35 with the movable leg of the mounting bracket in an extended configuration.

FIG. 41 is a perspective view of the coupling bracket of FIG. 35, according to some embodiments.

FIG. 42 is a bottom view of the coupling bracket of FIG. 35, according to some embodiments.

FIG. 43 is a side view of the coupling bracket of FIG. 35, according to some embodiments.

FIG. 44 is a side view of the coupling bracket coupled to the frame of FIG. 35, and with a shim positioned between the coupling bracket and rough opening framing, according to some embodiments.

FIG. 45 is a bottom-oriented, detail perspective view of features of the fenestration unit of FIG. 35, including the coupling bracket, the mounting bracket, and the retainer, and rough opening framing, according to some embodiments.

### DETAILED DESCRIPTION

### Definitions and Terminology

This disclosure is not meant to be read in a restrictive manner. For example, the terminology used in the application should be read broadly in the context of the meaning those in the field would attribute such terminology.

With respect to terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error, differences in measurement and/or manufacturing equipment calibration, human error in reading and/or setting measurements, minor adjustments made to optimize performance and/or structural parameters in view of differences in measurements associated with other components, particular implementation scenarios, imprecise adjustment and/or manipulation of objects by a person or machine, and/or the like, for example. In the event it is determined that individuals having ordinary skill in the relevant arts would not readily ascertain values for such reasonably small differences, the terms “about” and “approximately” can be understood to mean plus or minus 10% of the stated value.

Persons skilled in the art will readily appreciate that various aspects of the present disclosure can be realized by any number of methods and apparatuses configured to perform the intended functions. It should also be noted that the accompanying drawing figures referred to herein are not necessarily drawn to scale and may be exaggerated to illustrate various aspects of the present disclosure, and in that regard, the drawing figures should not be construed as limiting.

### Description of Various Embodiments

Various concepts of this patent specification address installation systems and methods for fenestration units, such as windows and doors. Some features of such systems and methods include one or more of the following: configured to be set into a rough opening from an interior side of a building or wall; eliminated or reduced need for jamb and/or sill spacers; pre-applied sill spacers (e.g., factory-applied); pre-applied head stabilizers and/or jamb stabilizers for self-stabilization in the rough opening while leveling, plumbing, squaring, and/or anchoring the fenestration unit; gauged to the interior face of the rough opening for more accurate finishing (e.g., drywall and/or trim) offsets; attached with pre-applied (e.g., factory-applied) mounting brackets configured for interior unit installation; shipped or supplied with mounting brackets configured for interior unit installation; no or reduced fasteners utilized on the exterior side of the fenestration unit; pre-attached (e.g., factory-applied) exterior water barrier (e.g., pop-up fin); storable and deployable exterior water barrier (e.g., constrained by removable packaging clips for shipping/installation); facilitates standard flashing tape methods; configured to be installed by a single person/installer; interior and exterior installation tasks can be performed at different times (e.g., with a substantial break in period of time between the two types of tasks).

In various examples, the fenestration units (e.g., fenestration unit 100) include features that promote installation of the fenestration unit from an interior side of a rough opening using a methodology that can be readily achieved by a single installer. In particular, a fenestration unit according to various examples includes a retention system coupled to the frame of the fenestration unit that is operable to exert a retention force on the fenestration unit to maintain positive engagement of the fenestration unit with the rough opening framing and resist extraction of the fenestration unit from the rough opening upon insertion of the fenestration unit in the rough opening from the interior side of the rough opening. The retention system may operate such that the fenestration unit remains stationary in the rough opening without use of fasteners securing the fenestration unit to the rough opening framing. The fenestration unit may include an engagement system coupled to the frame, the engagement system configured to positively engage the interior face of the rough opening framing upon insertion of the fenestration unit in the rough opening from the interior side of the rough opening. In turn, the aforementioned retention system may operate to maintain positive engagement of the retention system with the rough opening framing upon insertion of the fenestration unit in the rough opening from the interior side of the rough opening and without use of fasteners securing the fenestration unit to the rough opening framing.

In this manner, a single individual may insert a fenestration unit into a rough opening from the interior side thereof, without needing a second person to hold the fenestration unit against the rough opening framing, or otherwise assist with maintaining the positioning of the fenestration unit in the rough opening. This retention feature also removes the need for the installer to use one hand to hold the fenestration unit against the rough opening framing, freeing both hands of the installer to carry out the installation process, such as securing the fenestration unit to the rough opening using fasteners, such as nails or screws, and/or leveling, plumbing, and squaring the fenestration unit within the rough opening.

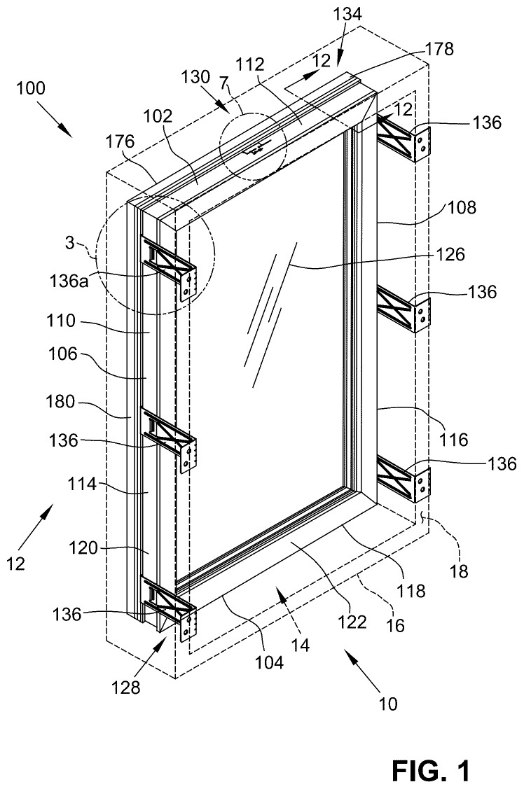

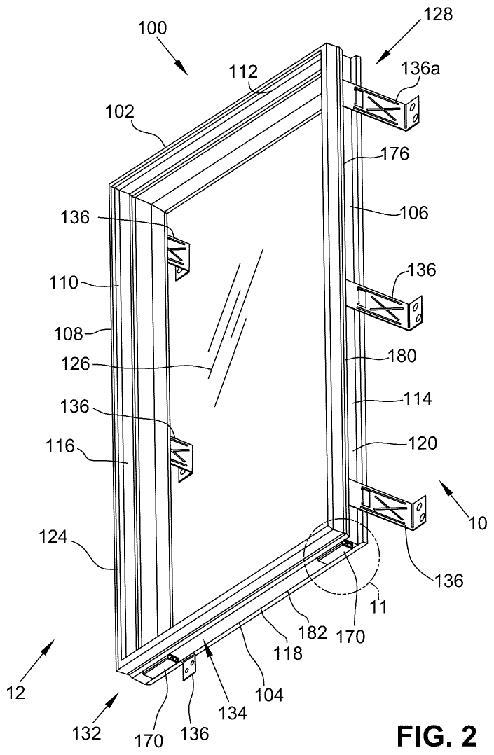

FIGS. 1 and 2 illustrate a fenestration unit 100, according to some embodiments, where FIG. 1 is a top-oriented perspective view from an interior side 10 of a building or wall and FIG. 2 is a bottom-oriented perspective view from an exterior side 12 of the building or wall. FIGS. 1 and 2 illustrate the fenestration unit 100 in an installing configuration in which the unit 100 is configured for positioning in a rough opening 14 defined by rough opening framing 16 (illustrated in phantom lines in FIG. 1) of the building or wall. As described in further detail below, the fenestration unit 100 is also configurable in an initial, or pre-installation configuration (e.g., as initially received by an installer) and a final, installed configuration, or installation configuration (e.g., secured in the rough opening).

As shown in FIGS. 1 and 2, the fenestration unit 100 generally includes a top 102, a bottom 104, a first side 106, and a second side 108. The fenestration unit 100 includes a frame 110 including a head 112, a first jamb 114, a second jamb 116, and a sill 118. These components of the frame 110 together define an outer perimeter 120, a front or interior face 122 (FIG. 1), as well as a back or exterior face 124 (FIG. 2). As illustrated, the frame 110 may be a vinyl frame design. However, fiberglass, wood, or other materials may be implemented for the frame 110.

The fenestration unit 100 also includes a panel unit or glazing unit 126 supported by the frame 110. The glazing unit 40 may be any of a variety of configurations, but in some embodiments is an insulated glass (IG) unit. As shown, the fenestration unit 100 is configured as a fixed window, but any of a variety of configurations (casement, single hung, double hung, awning or other) are also contemplated.

As shown in FIGS. 1 and 2, the fenestration unit 100 includes one or more installation features that facilitate installation of the fenestration unit 100 in the rough opening 14. For example, as shown, the fenestration unit 100 may include one or more of the following installation features: a mounting bracket system 128 (also described as an engagement system), a retention system including an installation stabilizer system 130 (FIG. 1) and a sill spacer system 132 (FIG. 2), a weather seal system 134. These features are described in further detail below.

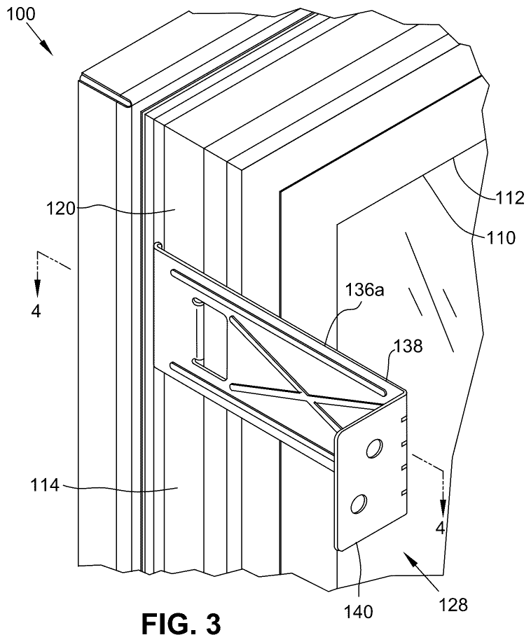

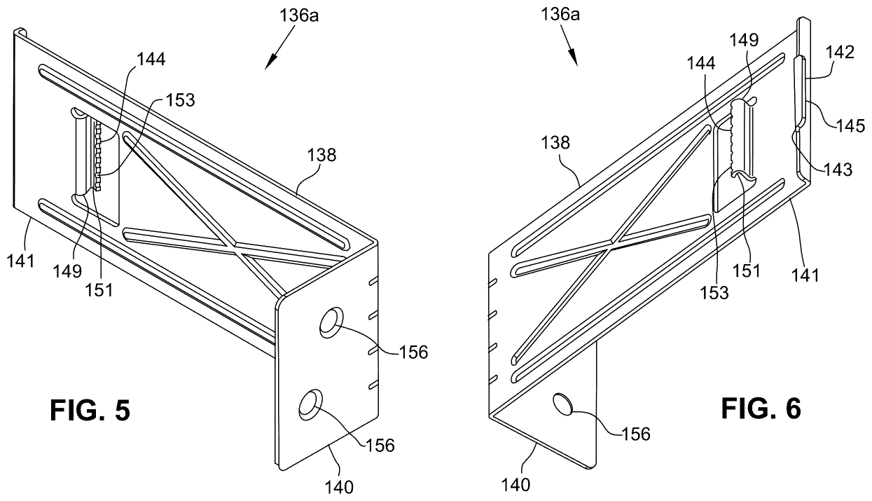

With continued reference to FIGS. 1 and 2 and additional reference to FIGS. 3-6, the mounting bracket system 128 generally includes a plurality of mounting brackets 136 coupled to the outer perimeter 120 of the frame 110. The mounting bracket system 128 may include various numbers of mounting brackets 136, such as four (4), six (6), eight (8), ten (10), or more mounting brackets 136. In some embodiments, half of the mounting brackets 136 are coupled to the first jamb 114 and half of the mounting brackets 136 are coupled to the second jamb 116, although a variety of configurations are contemplated, including mounting brackets 136 on the head 112 and/or sill 118. Generally, embodiments include at least four (4) mounting brackets 136, two upper mounting brackets 136 toward the head 112 and two lower mounting brackets 136 toward the sill 118. As the dimensions of the fenestration unit 100 increase, more mounting brackets 136 may be warranted to facilitate anchoring of the fenestration unit 100.

As described in further detail below, the mounting brackets 136 may be sized to provide an intended depth, or gauged, for installation (e.g., to accommodate jamb extensions and/or interior wall covering (e.g., drywall) returns). That is, the mounting brackets 136 may facilitate gauging the fenestration unit 100 from an interior face 18 of the rough opening 14 (FIG. 1). This gauging capability helps ensure a proper offset for interior wall covering thickness or other wall features and may help eliminate or reduce such problems as jamb extensions of the fenestration unit 100 being “proud” or “recessed” from an interior face of the finished wall surface (e.g., inner drywall face). The resulting installation using the mounting brackets 136 may facilitate flush jamb extensions relative to the interior face of the wall (e.g., inner drywall face) which makes the installation of trim (e.g., casing) of the fenestration unit 100 much more efficient for subsequent detailing steps (e.g., finish carpenters).

In some implementations, the mounting brackets 136 are initially provided to an installer (e.g., shipped or delivered to the installer) in an initial or pre-installation configuration in which the mounting brackets 136 are detached from the frame 110. As part of the installation process, an installer (not shown) positions each mounting bracket 136 at appropriate location along the perimeter 120 of the frame 110 (e.g., a pre-selected location or an installer-selected location, as described in further detail below) and couples the mounting bracket 136 to the frame 110 (e.g., by camming, or rotating, the mounting bracket 136 into a receiving feature in the frame 110 and, optionally, striking the mounting bracket 136 with a mallet or other tool, or pressing on the mounting bracket 136 by hand). Specific features of the mounting brackets 136 that facilitate coupling to the frame 110 are described in further detail below.

As shown in FIGS. 1 and 2, the mounting brackets 136 may each be substantially similar to one another and may be described cumulatively in association with a first one of the mounting brackets 136, an example of which (a first mounting bracket 136a) is depicted in FIGS. 3-5.

As shown in FIGS. 3-5, the first mounting bracket 136a generally includes a first leg 138 and a second leg 140. The first leg 138 and the second leg 140 may be integrally formed, or monolithically coupled, by fabricating the first mounting bracket 136a via sheet metal stamping and bending processes. In other embodiments, the first mounting bracket 136a may be fabricated using other materials and/or processes (e.g., cast or molded), and the first leg 138 and the second leg 140 may be coupled in other manners, such a via one or more fasteners, welds, or otherwise (not shown).

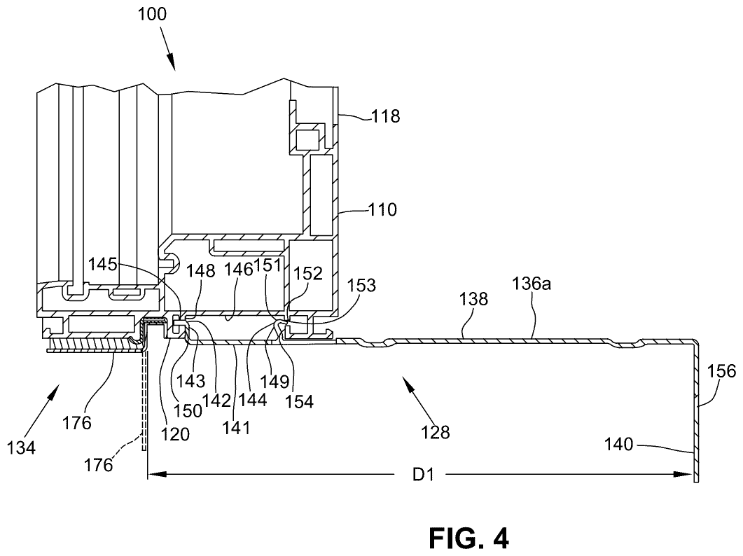

Referring specifically to FIGS. 4-6, the first leg 138 of the first mounting bracket 136a includes one or more first feet 142 (illustratively one first foot 142) and one or more second feet 144 (illustratively one second foot 144) that are generally disposed apart from the second leg 140. As shown, an end portion 141 of the first leg 138 extends between the first foot 142 and the second foot 144. In some embodiments and as illustrated, each first foot 142 includes an ankle portion 143 and an angled toe portion 145 coupled to the ankle portion 143. Similarly, in some embodiments and as illustrated, each second foot 144 includes an ankle portion 149 and an angled toe portion 151 coupled to the ankle portion 149. In certain embodiments and as illustrated, each second foot 144 further includes one or more claws 153 extending from the angled toe portion 151. In some embodiments and as illustrated, the claws 153 collectively form a serrated edge-like structure. In some embodiments and as illustrated, the toe portion 151 and the claws 153 project at an acute angle from the ankle portion 149.

The first foot 142 and the second foot 144 are received in a channel 146 formed on the perimeter 120 of the frame 110 to secure the first mounting bracket 136a to the frame 110. More specifically and referring to FIG. 4, the first foot 142, specifically the angled toe portion 145, is received in a first slot 148 formed in first sidewall 150 of the channel 146, and the second foot 144, specifically the angled toe portion 151 and the claws 153, is received in a second slot 152 formed in the second sidewall 154 of the channel 146. Illustratively, the first sidewall 150 and the second sidewall 154 may face toward each other, and accordingly the first slot 148 and the second slot 152 may face toward each other, and the first foot 142 and the second foot 144 accordingly may face away from each other to facilitate receipt in the first slot 148 and the second slot 152, respectively. In other embodiments, the first foot 142 and the second foot 144 may have different arrangements depending on the arrangement of the first slot 148 and the second slot 152. The first foot 142 and the second foot 144 and/or the first sidewall 150 and the second sidewall 154 may be sufficiently flexible to facilitate bending and receiving the feet 142, 144 in the slots 148, 152, respectively, when coupling the mounting bracket 136a to the frame 110. In some embodiments, the mounting bracket 136a is coupled to the frame 110 by camming, or rotating, the bracket 136a relative to the frame 110. More specifically, the first foot 142 is inserted into the first slot 148 of the channel 146, then the second foot 144 is inserted into the second slot 152 of the channel 146. In some embodiments, the second foot 144 is driven past the second sidewall 154 and into the second slot 152 by applying additional force to the mounting bracket 136a (e.g., by pressing on the mounting bracket 136a by hand, striking the mounting bracket 136a with a mallet, or the like). The first slot 148 and the second slot 152 may be formed in the first sidewall 150 and the second sidewall 154, respectively, at pre-selected locations or continuously about the perimeter 120 of the frame 110. The first slot 148 and the second slot 152 may be formed on the frame 110 in cutting process (e.g., using a key seat cutter) or otherwise. In other embodiments, the mounting brackets 136 may be coupled to the frame 110 in additional or other manners, such as via fasteners, more specifically screws or rivets, or adhesives, such as very high bond (VHB) tape.

As described briefly above and referring specifically to FIG. 4, the mounting brackets 136 may be sized to provide an intended depth for installation. More specifically, the length of the mounting brackets 136 between the rear edge of a fin assembly 176 of the weather seal system 134 (in its unconstrained or deployed configuration, shown in phantom lines, as described in further detail below) and the second legs 140 may be sized to provide the intended depth D1 for installation. The length of the mounting brackets 136 may provide an intended installation depth D1, e.g., in a range of 3.750 to 4.125 in. for a 2×4 wall and a range of 5.750 in. to 6.125 in. for a 2×6 wall.

With reference again to FIGS. 3-6, the second leg 140 of the first mounting bracket 136a extends approximately perpendicularly from the first leg 138 and outward relative to the frame 110. The second leg 140 is configured to abut the interior face 18 of the rough opening framing 16 (FIG. 1) and thereby properly position the fenestration unit 100 in the rough opening 14. The second leg 140 includes one or more apertures 156 (illustratively, two apertures 156), and each aperture 156 is configured to receive a fastener (not shown) for securing the fenestration unit 100 to the rough opening framing 16. The apertures 156 may be recessed or countersunk to permit screw heads to be mounted flush. In this way, the fasteners will not interfere with an interior wall covering (e.g., drywall) or other wall treatment installed over the second leg 140.

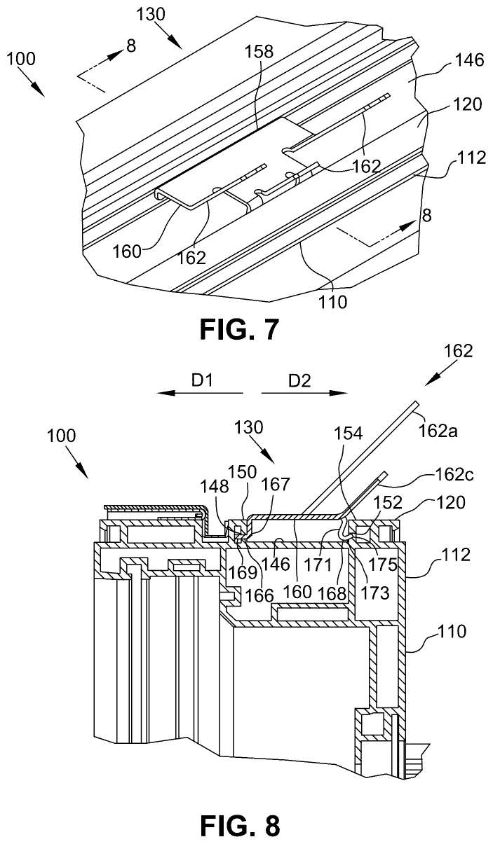

With reference to FIGS. 7-10, the installation stabilizer system 130 includes one or more retainers 158, also described as stabilizer clips 158. In some embodiments and as illustrated, the installation stabilizer system 130 includes one retainer 158. In some embodiments, the retainer 158 may be detached from the frame 110 in the pre-installation configuration. In other embodiments, the retainer 158 may be coupled to the frame 110 in the pre-installation configuration. In some embodiments and as illustrated, the retainer 158 is positioned on the head 112 of the frame 110. The retainer 158 may be fabricated by sheet metal stamping and bending processes.

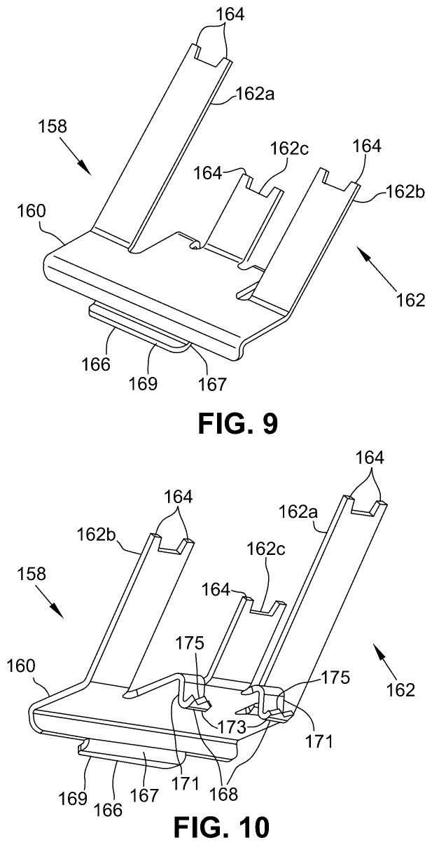

Generally, the retainer 158 is configured to permit insertion of the frame 110 within the rough opening 14 (shown elsewhere) in a first insertion direction D1 (FIG. 8) and resist extraction of the frame 110 from the rough opening 14 in a second extraction direction D2 (FIG. 8). The retainer 158 includes a base 160 configured to be secured to the frame 110 (FIGS. 7 and 8), and one or more flex arms 162 extending from the base 160. Each flex arm 162 includes one or more engagement features 164 (FIGS. 9 and 10) at a terminal end. In some embodiments and as illustrated, the engagement features 164 are generally rectangular teeth-like structures that are configured to “bite” into the rough opening framing. In some embodiments and as illustrated, one or more of the flex arms 162 may have a different length and/or extend from the base 160 at a different position than other flex arms 162. For example and as illustrated in FIGS. 9 and 10, the retainer 158 includes a first flex arm 162a extending from a first side of the base 160, a second flex arm 162b extending from a second side of the base 160, and a third flex arm 162c generally disposed between the first flex arm 162a and the second flex arm 162b. In some embodiments and as illustrated, the first flex arm 162a has a first length, the second flex arm 162b has a second length less than the first length, and the third flex arm 162c has a third length less than the second length. In some embodiments, the different lengths of the flex arms 162 advantageously permit the fenestration unit 100 to be installed in rough openings of various sizes, in particular rough openings that provide different gap sizes between the head 112 of the frame 100 and the rough opening framing. In some embodiments and as illustrated, the third flex arm 162c extends from the base 160 at a position that is horizontally offset (e.g, as shown in FIG. 8) from a position on the base 160 from which the first flex arm 162a and the second flex arm 162b extend. In certain embodiments, this arrangement of the flex arms 162a, 162b, and 162c advantageously inhibits the relatively long arms (that is, the first flex arm 162a and the second flex arm 162b) from extending past the interior face 122 of the frame 100 (shown elsewhere) when positioned in the rough opening. In some embodiments, all of the flex arms 162 may have the same length and/or extend from the base 160 at the same position. In some embodiments and as illustrated, the flex arms 162a, 162b, and 162c extend from the base 160 at the same angle. In some embodiments, the flex arms 162a, 162b, and 162c extend from the base 160 different angles, or are otherwise structured to provide the flex arms 162a, 162b, and 162c with different heights relative to the base 160. Stated another way, in some embodiments the first flex arm 162a has a first height relative to the base 160, the second flex arm 162b has a second height relative to the base 160 less than the first height, and the third flex arm 162c has a third height relative to the base 160 less than the second height.

In some embodiments, the base 160 includes one or more first feet 166 (illustratively one first foot 166) and one or more second feet 168 (illustratively two second feet 168) for securing the retainer 158 to the frame 110. In some embodiments and as illustrated, each first foot 166 includes an ankle portion 167 and an angled toe portion 169 coupled to the ankle portion 167. Similarly, in some embodiments and as illustrated, each second foot 168 includes an ankle portion 171 and an angled toe portion 173 coupled to the ankle portion 171. In certain embodiments and as illustrated, each second foot 168 further includes one or more claws 175 extending from the angled toe portion 173. The claws 175 may collectively form a serrated edge-like structure. In some embodiments and as illustrated, the toe portion 173 and the claws 175 project at an acute angle from the ankle portion 171.

The first foot 166 and the second feet 168 are received in the channel 146 (FIGS. 7 and 8) formed on the perimeter 120 of the frame 110 to secure the retainer 158 to the frame 110. More specifically and referring to FIG. 8, the first foot 166, specifically the angled toe portion 169, is received in the first slot 148 formed in first sidewall 150 of the channel 146, and the second feet 168, more specifically the angled toe portions 173 and the claws 175, are received in the second slot 152 formed in the second sidewall 154 of the channel 146. Illustratively, the first sidewall 150 and the second sidewall 154 may face toward each other, and the first foot 166 and the second feet 168 accordingly may face away from each other to facilitate receipt in the first slot 148 and the second slot 152, respectively. In other embodiments, the first foot 166 and the second feet 168 may have different arrangements depending on the arrangement of the first slot 148 and the second slot 152. The first foot 166 and the second feet 168 and/or the first sidewall 150 and the second sidewall 154 may be sufficiently flexible to facilitate bending and receiving the feet 166, 168 in the slots 148, 152 when coupling the retainer 158 to the frame 110 In some embodiments, the retainer 158 is coupled to the frame 110 by camming, or rotating, the retainer 158 relative to the frame 110. More specifically, the first foot 166 is inserted into the first slot 148 of the channel 146, then the second feet 168 are inserted into the second slot 152 of the channel 146. In some embodiments, the second feet 168 are driven past the second sidewall 154 and into the second slot 152 by applying additional force to the retainer 158 (e.g., by pressing on the retainer 158 by hand, striking the retainer 158 with a mallet, or the like). In some embodiments, the retainer 158 may be coupled to the frame 110 in other manners, such as via adhesion or fasteners.

During insertion of the frame 110 in the first insertion direction D1 (FIG. 8), one or more of the flex arms 162 of the retainer 158 (e.g., the longest flex arm 162 if a large gap is present between the frame 110 and the rough opening framing 16 or all of the flex arms 162 if a small gap is present) bends or is deflected in a first flex direction. The insertion force, or force required to move the unit 100 in the first direction D1 may be, for example, 1 lb. or less, more than 1 lb, more than 10 lbs, or more than 15 lbs. Upon application of a force on the frame 110 in the second extraction direction D2, the flex arm 162 bends in a second flex direction to resist movement of the frame 110 in the second direction D2 (e.g., toward the interior side). The extraction or tipping force, or force required to move the unit 100 in the second direction D2 after seating may be greater than the insertion force. The extraction force may be, for example, 1 lb. or less, more than 1 lb, 10 lbs or more, at least 15 lbs, or 15 lbs or more. In some examples, the extraction force is 80 lbs or more, or approximately 88 lbs. Generally, a higher extraction or tipping force (e.g., as compared to the insertion force) helps ensure the fenestration unit 100 remains in place after being inserted into the rough opening 14 to permit subsequent levelling and/or securement procedures.

Further aspects of the installation stabilizer system 130 and the retainer(s) 158 may be as described in U.S. application Ser. No. 18/478,189, filed Sep. 29, 2023, the disclosure of which is hereby incorporated by reference for all purposes.

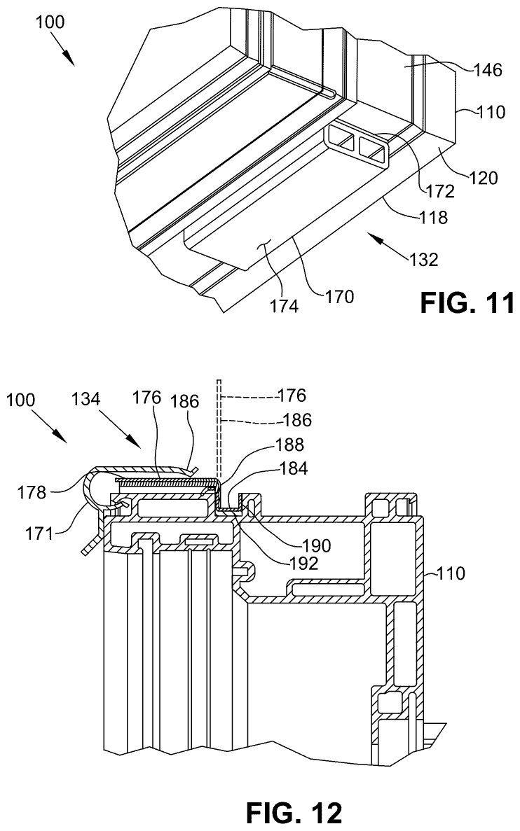

Referring to FIG. 11 and with additional reference to FIG. 2, the sill spacer system 132 includes one or more sill spacers 170, such as a pair of sill spacers 170 (one spacer 170 being illustrated in FIG. 11, both spacers being illustrated in FIG. 2), attached to the bottom of the frame 110 at the sill 118. In some embodiments, the sill spacers 170 may be detached from the frame 110 in the pre-installation configuration. In other embodiments, the sill spacers 170 may be coupled to the frame 110 in the pre-installation configuration.

In some embodiments, the sill spacer system 132 provides a convenient mechanism for positioning and leveling the fenestration unit 100 inside the rough opening 14 (shown elsewhere). In some embodiments, the sill spacer system 132 facilitates centering the fenestration unit 100 within the rough opening 14 by reducing friction between the frame 110 of the fenestration unit 100 and the rough opening 14 as they move against each other. The sill spacer system 132 establishes a gap between the rough opening 14 and the sill 118 to make it easier for an installer to adjust the position of the fenestration unit 100 (e.g., insert a pry bar or other tool under the sill 118 of the fenestration unit 100 for lifting and leveling). Shims, such as standard wood shims, can be slid under the sill spacer system 132 for leveling the fenestration unit 100 within the rough opening 14.

With continued reference to FIG. 11, each sill spacer 170 may be positioned in the channel 146 formed on the perimeter 120 on the frame 110. In some embodiments and as illustrated, each sill spacer 170 may be coupled to the frame 110 via an adhesive 172. In other embodiments, the sill spacer(s) 170 may be coupled to the frame 110 in other manners, such as via fasteners or a plurality of feet, such as feet similar to those of the mounting bracket 136a or the retainer 158 (shown elsewhere). In some embodiments and as illustrated, each sill spacer 170 includes a flat lower contact surface 174. Stated another way, each sill spacer 170 is substantially rectangular and lacks any angles or ramps. In some embodiments, each sill spacer 170 includes standard rounds or chamfers on corners typical of molding and/or extrusion processes. In some embodiments, the substantially rectangular shape of the sill spacer 170 advantageously provides no directionality for installation of the unit 100, maximizes the contact surface of the sill spacer 170, and/or facilitates level seating of the unit 100 in a rough opening. In other embodiments, each sill spacer 170 includes a rounded lower contact surface, and/or any of the features of the sill spacers described in U.S. Application No. 18/478, 189, filed Sep. 29, 2023, previously incorporated by reference.

Referring to FIG. 12, and with additional reference to FIGS. 1 and 2, the weather seal system 134 acts as an exterior water barrier. The weather seal system 134 may be biased to a deployed configuration or may be otherwise described as a “pop-up” fin system. In various examples, the weather seal system 134 is initially provided (e.g., in the pre-installation configuration and the installing configuration shown in FIGS. 1 and 2) in a stowed or flattened position against the frame 110 of the fenestration unit 100. This stowed or flattened position can be described as a “180° position”. The weather seal system 134 may be held in the stowed position by a detachable retaining assembly 171. After the fenestration unit 100 is installed and anchored (e.g., using one or more fasteners, such as screws or nails) the original installer(s) (not shown) or another installer or installer(s) may separately proceed to the exterior side of the rough opening 14 to remove the retaining assembly and transition the weather seal system 134 to the deployed configuration (and the unit 100 thereby reaching its final, installation configuration). In some examples, upon removal of the retaining assembly, the weather seal system 134 automatically pops-up, or projects outwardly from the frame 110 (as shown in phantom lines in FIG. 12; e.g., at approximately 90°, or biased to rotate beyond 90° to encourage positive engagement) to rest against the exterior surface of the wall in which the rough opening 14 is formed.

In various examples, no fasteners (e.g., screws or nails) are used on the exterior side of the fenestration unit 100 (e.g., the fenestration unit 100 is secured entirely from the interior side of the rough opening 14). Flashing tape or other treatments may be applied around the perimeter of the fenestration unit 100, over the weather seal system 134 to seal the fenestration unit 100 to the exterior surface of the wall in which the rough opening 14 is formed. In various examples, the exterior surface of the wall may include a weather resistant barrier (e.g., Tyvek® home wrap available from DuPont de Nemours, Inc.).

With continued reference to FIG. 12 and additional reference to FIGS. 1 and 2, the weather seal system 134 includes the fin assembly 176, which is outwardly biased to project radially outward from the perimeter 120 of the frame 110 when unconstrained. The fin assembly 176 generally includes a plurality of fins, including a head fin 178, a first jamb fin 180, a second jamb fin (not shown), and a sill fin 182. FIG. 12 is a section view of the head fin 178 and the other fins each may have a substantially similar construction, with differences in length corresponding to the portion of the frame 110 to which they are attached. As shown, each of the fins includes a coupling portion 184, a projection portion 186, and a hinge portion 188 between the coupling portion 184 and the projection portion 186. The coupling portion 184 is disposed in a channel 190 formed in the perimeter 120 (FIGS. 1 and 2) of the frame 110 and the projection portion 186 is biased by the hinge portion 188 to project radially outward from the perimeter 120 in the deployed configuration. In some embodiments, the coupling portion 184 may be coupled to the frame 110 via an adhesive 192. However, other attachment methods are contemplated, including any of those previously described.

Other aspects of the weather seal system 134 and the fin assembly 176 may be as described in U.S. application Ser. No. 18/478,189, filed Sep. 29, 2023, previously incorporated by reference. For example, the weather seal system 134 may further include corner bridge seals between the fins and/or a retaining assembly for initially holding the fin assembly 176 in the stowed position as described in the incorporated application. As another example, the fin assembly 176 may include features, such as the dimples described in the incorporated application, or waffling features debossed into the fin assembly 176 that facilitate venting such that the water-managed cavity between the frame 110 and the rough opening is at exterior air pressure.

Installation of the fenestration unit 100 may proceed in view of the various concepts described in the foregoing sections. In particular, installation of the fenestration unit 100 in the rough opening 14 may proceed from the interior side of the rough opening 14 and may be executed by a single installer initially on the interior side of the rough opening 14.

As part of the installation process, the rough opening 14 should be prepared for installation of the fenestration unit 100. Generally, the rough opening 14 is sized to be between ½ inches and ¾ inches larger than the fenestration unit 100 in both width and height, although other setups may also be suitable. Some methods also include forming the rough opening 14, such as by cutting out the rough opening (e.g., plywood cladding covering rough opening framing). The sill portion of the rough opening framing 16 (i.e., the lower framing) may be flashed (e.g., using appropriate flashing tape).

The fenestration unit 100 is then partially deployed from the pre-installation configuration to the installing configuration. In some examples, the brackets 136 and the retainer 158 are initially supplied with the unit 100 in shipping packaging (not shown). In some examples, the brackets 136 are supplied as a kit of parts, with a variety of different configurations to facilitate different installation scenarios (e.g., having different lengths for facilitating different registration depths in the rough opening 14). In some embodiments, the, the mounting brackets 136 and the retainer 158 are coupled to the frame 110 of the unit 100 to partially deploy from the pre-installation configuration to the installing configuration. In some embodiments, the brackets 136 are coupled to the frame 110 by positioning the first feet 142 and second feet 144 in the channel 146 as described above, and the retainer 158 is coupled to the frame 110 by positioning the first foot 142 and the second foot 144 in the channel 146 as described above.

The fenestration unit 100 is inserted or pushed unit into the rough opening 14 from the interior side of the rough opening 14, for example by a single installer. The ability and functionality to be installed from an interior side of the rough opening 14 may be an advantageous feature of the fenestration unit 100, as traditional fenestration installations require at least one installer on the exterior side of a rough opening and/or at least one installer on the interior side of the rough opening.

In some embodiments, the fenestration unit 100 is inserted into the rough opening 14 by first inserting a bottom of the fenestration unit 100 into the rough opening 14 and then tilting the top of the fenestration unit 100 toward an exterior side of the rough opening 14 such that the installation stabilizer system 130 exerts a retention force on the fenestration unit 100 by maintaining positive engagement of the fenestration unit 100 with the rough opening framing 16. The installation stabilizer system 130 permits insertion of the fenestration unit 100 within the rough opening 14 in a first, interior-to-exterior direction at a first insertion force and resist extraction of the fenestration unit from the opening in a second, exterior-to-interior direction at a second extraction force, the second extraction force being substantially greater than the first insertion force. The method includes inserting the fenestration unit 100 within the rough opening 14 in the first direction at a force that meets or exceeds the insertion force.

The fenestration unit 100 is pushed into the rough opening 14 until the mounting brackets 136 engage the rough opening framing 16, specifically the jamb portions of the rough opening framing 16. The mounting brackets 136 act as an engagement system that is positively engaged with the interior face of the rough opening framing 16 from the interior side of the rough opening 14 and the installation stabilizer system 130 maintains positive engagement of the engagement system with the rough opening framing 16 upon insertion therein.

The fenestration unit 100 is then centered in the rough opening 14. In some embodiments, the fenestration unit 100 begins spaced from the sill portion of the rough opening framing 16 a desired distance due to the thickness of the sill spacers 170. In some embodiments, this distance is approximately ¼ inches. The fenestration unit 100 may be centered side-to-side by inserting a screwdriver having a standard head (e.g., ¼-inch-thick head) and rotating the screw driver to ensure a minimum desired gap is achieved at the first and second jambs 114, 116 of the frame 110. To begin the shimming/levelling processes, a level is used to check the horizontal level of the fenestration unit 100 and a single shim is slid underneath the low side sill spacer 170. Additional shims are applied as needed to achieve a desired level and sill spacing with periodic measuring of horizontal level as needed.

Once a desired levelling and spacing is achieved, fasteners (e.g., screws or nails) are driven through the lowermost mounting brackets 136 and into the rough opening framing 16. The fenestration unit 100 can then continue to be plumbed, squared, and fully coupled to the rough opening framing 16. For example, a user may plumb one of the first jamb 114 and the second jamb 116 to vertical level. This operation of adjusting vertical level at the first jamb 114 and/or the second jamb 116 may be carried out using a tool (e.g., a crowbar or prybar) to adjust the plumb of the jambs 114, 116. Additionally, or alternatively, an installer may use an air bag designed for such a purpose that can be inflated to adjust the gap between the jambs 114, 116 and the rough opening framing, and thus vertical level thereof, or other suitable methods may be implemented as desired. Once plumbed to be vertically level, the remaining mounting brackets 136 are secured to the rough opening framing 16 using fasteners, such that the fenestration unit 100 is structurally secured to the rough opening framing 16.

The installer may apply an air sealant (e.g., spray foam or other air seal material) around the outer perimeter 120 of the fenestration unit 100 in the gap between the rough opening framing 16 and the fenestration unit 100 to create an interior air seal. This interior air seal may be continuous and substantially, or entirely, uninterrupted. An interior air seal typically is necessary for proper water management. As previously referenced, the positioning of the sill spacer system 132 helps provide sufficient gap for the air sealant to be deposited in the gap, and also provides a continuous gap around the perimeter of the fenestration unit 100 to ensure a continuous seal can be formed. This sealing operation is typically carried out from an interior side of the rough opening. Notably, the sealant may be applied before, or after the exterior water barrier steps described below in association with the weather seal system 134.

In contrast to other methods and systems, at this point the fenestration unit 100 is entirely squared, plumbed, and securely fastened in the rough opening 14 all from the interior side of the rough opening 14. This can be accomplished by a single installer, rather than requiring two installers. However, in the case of particularly large fenestration units, multiple installers may still be required to lift and position the fenestration unit. Regardless, at that time, or a later time as desired, the same installer, or another installer, may proceed to the exterior side of the rough opening 14 to finish exterior water barrier installation for the fenestration unit 100 in the rough opening. This is in contrast with traditional, nailing fin installations which require a second installer to be present on the exterior side of the rough opening during installation of the fenestration unit.

Forming an exterior water barrier for the installation unit 100 may include removing the retaining clips (not shown) such that the plurality of fins transition from the stowed configuration to a radial outwardly projecting installation, or deployed configuration. In various operations, the retaining clips may be removed in any order. In other operations, the retaining clip near the sill is removed first, followed by the retaining clips near the jambs, and finally the retaining clip near the head. This order can help ensure the proper overlapping of the fins and the corner bridge seals (not shown), with the sill fin 182 being outwardly overlapping with the jamb fins 180.

Generally, no fasteners are used with the fins, which is in contrast to traditional nailing fins. Though such fasteners (e.g., screws or nails) are not present in various examples, it is contemplated that such fasteners could be implemented in other embodiments. Regardless, installation proceeds by using flashing tape or another suitable flashing material to flash over the first and second jamb fins 180 and then the head fin 178. Generally, weather resistant barrier (e.g., Tyvek® home wrap available from DuPont de Nemours, Inc.) will be present on the exterior wall of a building and will be cut with two 45 degree cuts at the rough opening head corners and folded vertically against itself. Once the jamb fins 180 and the head fin 178 have been flashed, the weather resistant barrier can be folded back down over the head fin 178 and flashing (e.g., flashing tape) can be applied across the 45 degree cuts at the corners. Flashing (e.g., flashing tape) is not applied to the sill fin 182 in various examples. This absence of sealing at the sill 118 of the frame 110 can help ensure that the sill fin 182 acts as a water barrier, but not an air seal at the sill 118. This water-but-non-air barrier configuration promotes equalization of air pressure at a location under the sill 118 and exterior to the rough opening sealant to exterior air pressure. This equalization to exterior air pressure can help prevent water from being forced or drawn up through the water seal at the sill 118 during a storm or other high external ambient air pressure event.

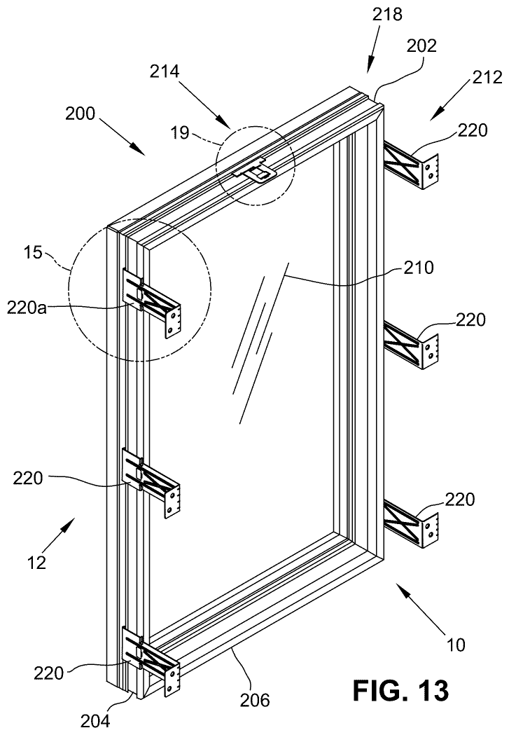

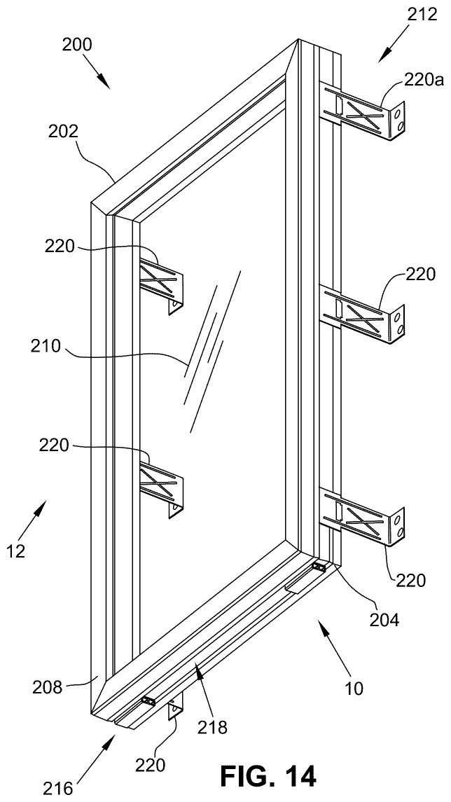

FIGS. 13 and 14 illustrate a fenestration unit 200, according to some embodiments, where FIG. 13 is a top-oriented perspective view from the interior side 10 of a building or wall and FIG. 14 is a bottom-oriented perspective view from an exterior side 12 of the building or wall. FIGS. 13 and 14 illustrate the fenestration unit 200 in an installing configuration in which the unit 200 is configured for positioning in a rough opening defined by rough opening framing (shown elsewhere) of the building or wall. The fenestration unit 200 is also configurable in an initial or pre-installation configuration (e.g., as initially received by an installer) and a final, installed configuration, or installation configuration (e.g., secured in the rough opening).

The fenestration unit 200 generally includes a frame 202 having an outer perimeter 204, a front or interior face 206 (FIG. 13), as well as a back or exterior face 208 (FIG. 14). As illustrated, the frame 202 may be a fiberglass frame design. However, vinyl, wood, or other materials may be implemented for the frame 202. The frame 202 supports a glazing unit 210, which may be any of a variety of configurations. As shown, the fenestration unit 200 is configured as a fixed window, but any of a variety of configurations (casement, single hung, double hung, awning or other) are also contemplated.

As shown in FIGS. 13 and 14, the fenestration unit 200 includes one or more installation features that facilitate installation of the fenestration unit 200 in the rough opening. For example, as shown, the fenestration unit 200 may include one or more of the following installation features: a mounting bracket system 212 (also described as an engagement system), a retention system including an installation stabilizer system 214 (FIG. 13) and a sill spacer system 216 (FIG. 14), a weather seal system 218. The components and systems of the fenestration unit 200 may be substantially similar to the corresponding components and systems of the fenestration unit 100, except as described below.

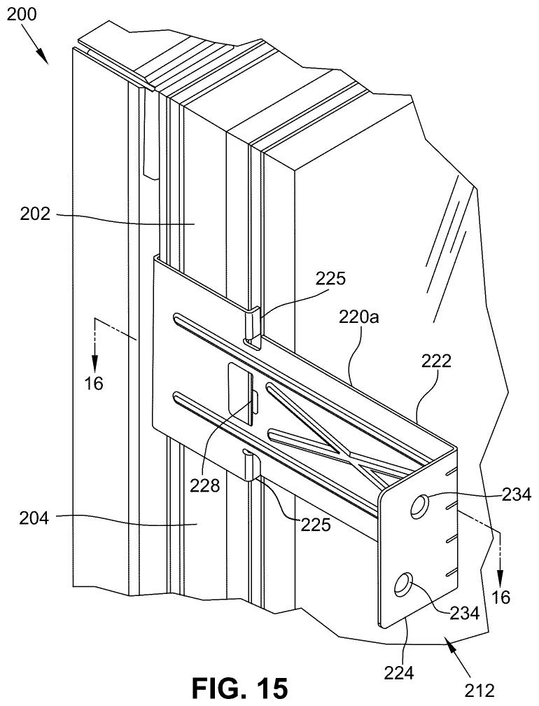

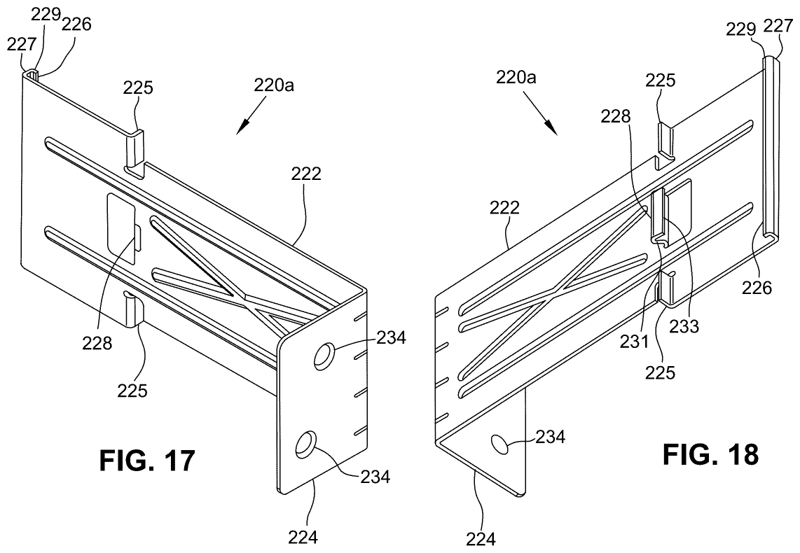

With continued reference to FIGS. 13 and 14 and additional reference to FIGS. 15-18, the mounting bracket system 212 generally includes a plurality of mounting brackets 220 that are couplable to the outer perimeter 204 of the frame 202. The mounting brackets 220 may each be substantially similar to one another and may be described cumulatively in association with a first one of the mounting brackets 220, an example of which (a first mounting bracket 220a) is depicted in FIGS. 15-18.

As shown in FIGS. 15-18, the first mounting bracket 220a generally includes a first leg 222 and a second leg 224. The first leg 222 and the second leg 224 may be integrally formed, or monolithically coupled, by fabricating the first mounting bracket 220a via sheet metal stamping and bending processes. In other embodiments, the first mounting bracket 220a may be fabricated using other materials and/or processes, and the first leg 222 and the second leg 224 may be coupled in other manners, such a via one or more fasteners (not shown). The first leg 222 of the first mounting bracket 220a includes one or more first feet 226 (illustratively one first foot 226) and one or more second feet 228 (illustratively one second foot 228) that are generally disposed apart from the second leg 224. In some embodiments and as illustrated, each first foot 226 includes an ankle portion 227 and an angled toe portion 229 coupled to the ankle portion 227. Similarly, in some embodiments and as illustrated, each second foot 228 includes an ankle portion 231 and an angled toe portion 233 coupled to the ankle portion 231. In some embodiments, guides 225 may be disposed on one or both sides of the second foot 228, and the guides 225 may contact the interior face 206 of the frame 202 to facilitate securing the mounting bracket 220a to the frame 202.

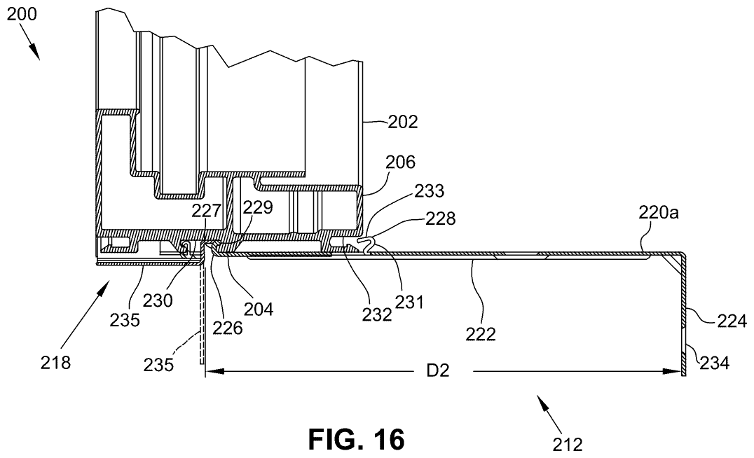

The first foot 226 and the second foot 228 are received in channels formed on the frame 202 to secure the first mounting bracket 220a to the frame 202. More specifically and referring to FIG. 16, the first foot 226, specifically the angled toe portion 229, is received in a first channel 230, more specifically an installation fin channel 230 formed on the perimeter 204 of the frame 202, and the second foot 228, specifically the angled toe portion 233, is received in a second channel 232, more specifically an accessory channel 232 formed on the interior face 206 of the frame 202. Illustratively, the first channel 230 and the second channel 232 face substantially perpendicularly relative to each other, and the first foot 226 and the second foot 228 accordingly may face toward each other to facilitate receipt in the first channel 230 and the second channel 232, respectively. In other embodiments, the first foot 226 and the second foot 228 may have different arrangements depending on the arrangement of the first channel 230 and the second channel 232. The first foot 226 and the second foot 228 and/or the portions of the frame 202 adjacent to the first channel 230 and the second channel 232 may be sufficiently flexible to facilitate bending and receiving the feet 226, 228 in the channels 230, 232 when coupling the mounting bracket 220a to the frame 202. In some embodiments, the mounting bracket 220a is coupled to the frame 202 by camming, or rotating, the bracket 220a relative to the frame 200. More specifically, the first foot 226 is inserted into the first channel 230, then the second foot 228 is inserted into the second channel 232. In some embodiments, the second foot 228 is driven into the second channel 232 by applying additional force to the mounting bracket 220a (e.g., by pressing on the mounting bracket 220a by hand, striking the mounting bracket 220a with a mallet, or the like). In other embodiments, the mounting brackets 220 may be coupled to the frame 202 in additional or other manners, such as via fasteners, more specifically screws or rivets, or adhesives, such as very high bond (VHB) tape.

Referring specifically to FIG. 16, the mounting brackets 220 may be sized to provide an intended depth for installation. More specifically, the length of the mounting brackets 220 between the rear edge of a fin assembly 235 of the weather seal system 218 (in its unconstrained or deployed configuration, shown in phantom lines, as described in further detail below) and the second legs 224 may be sized to provide the intended depth D2 for installation. The length of the mounting brackets 220 may provide an intended installation depth D2, e.g., in a range of 3.750 in. to 4.125 in., a range of 3.750 in. to 4.125 in. for a 2×4 wall, a range of 5.750 in. to 6.125 in. for a 2×6 wall, or larger ranges for larger walls.

In some embodiments, the weather seal system 218 facilitates coupling the mounting brackets 220 to the frame 202 at specific positions. More specifically, the fin assembly 235 of the weather seal system 218 may occupy the first channel 230 at various positions along the frame 202 and thereby inhibit the mounting brackets 220 from coupling to the frame 202 at those positions. In contrast, the fin assembly 235 may be notched, punched, or otherwise absent from the first channel 230 at various positions along the frame 202 (for example, the position shown in FIG. 16) and thereby permit the mounting brackets 220 to couple to the frame 202 at those positions.

With reference again to FIGS. 15-18, the second leg 224 of the first mounting bracket 220a extends approximately perpendicularly from the first leg 222 and outward relative to the frame 202. The second leg 224 is configured to abut the interior face of the rough opening framing and thereby properly position the fenestration unit 200 in the rough opening. The second leg 224 includes one or more apertures 234 (illustratively, two apertures 234), and each aperture 234 is configured to receive a fastener (not shown) for securing the fenestration unit 200 to the rough opening framing. The apertures 234 may be recessed or countersunk to permit screw heads to be mounted flush.

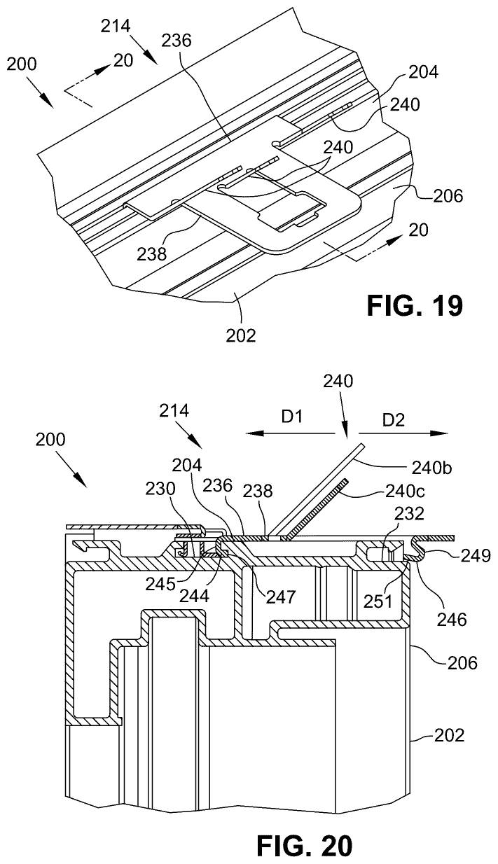

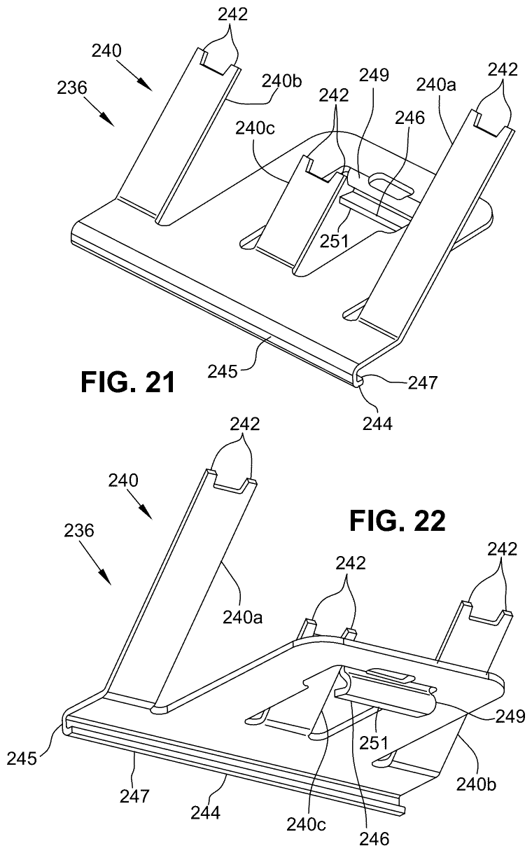

With reference to FIGS. 19-22, the installation stabilizer system 214 includes one or more retainers 236, also described as stabilizer clips 236. In some embodiments and as illustrated, the installation stabilizer system 214 includes one retainer 236. Generally, the retainer 236 is configured to permit insertion of the frame 202 within the rough opening in a first insertion direction D1 (FIG. 20) and resist extraction of the frame 202 from the rough opening in a second extraction direction D2 (FIG. 20). The retainer 236 includes a base 238 configured to be secured to the frame 202 (FIGS. 19 and 20), and one or more flex arms 240 extending from the base 238. Each flex arm 240 includes one or more engagement features 242 (FIGS. 21 and 22) at a terminal end. In some embodiments and as illustrated, the engagement features 242 are generally rectangular teeth-like structures that are configured to “bite” into the rough opening framing. In some embodiments and as illustrated, one or more of the flex arms 240 may have a different length and/or extend from the base 238 at a different position than other flex arms 240. For example and as illustrated in FIGS. 21 and 22, the retainer 236 includes a first flex arm 240a extending from a first side of the base 238, a second flex arm 240b extending from a second side of the base 238, and a third flex arm 240c generally disposed between the first flex arm 240a and the second flex arm 240b. In some embodiments and as illustrated, the first flex arm 240a has a first length, the second flex arm 240b has a second length less than the first length, and the third flex arm 240c has a third length less than the second length. In some embodiments, the different lengths of the flex arms 240 advantageously permit the fenestration unit 200 to be installed in rough openings of various sizes, in particular rough openings that provide different gap sizes between the head of the frame 202 and the rough opening framing. In some embodiments and as illustrated, the third flex arm 240c extends from the base 238 at a position that is horizontally offset (e.g., as shown in FIG. 20) from a position on the base 238 from which the first flex arm 240a and the second flex arm 240b extend. In certain embodiments, this arrangement of the flex arms 240a, 240b, and 240c advantageously inhibits the relatively long arms (that is, the first flex arm 240a and the second flex arm 240b) from extending past the interior face 206 of the frame 202 (shown elsewhere) when positioned in the rough opening. In some embodiments, all of the flex arms 240 may have the same length and/or extend from the base 238 at the same position. In some embodiments and as illustrated, the flex arms 240a, 240b, and 240c extend from the base 238 at the same angle. In some embodiments, the flex arms 240a, 240b, and 240c extend from the base 238 different angles, or are otherwise structured to provide the flex arms 240a, 240b, and 240c with different heights relative to the base 238. Stated another way, in some embodiments the first flex arm 240a has a first height relative to the base 238, the second flex arm 240b has a second height relative to the base 238 less than the first height, and the third flex arm 240c has a third height relative to the base 238 less than the second height.

In some embodiments, the base 238 includes one or more first feet 244 (illustratively one first foot 244) and one or more second feet 246 (illustratively one second foot 246) for securing the retainer 236 to the frame 202. In some embodiments and as illustrated, each first foot 244 includes an ankle portion 245 and an angled toe portion 247 coupled to the ankle portion 245. Similarly, in some embodiments and as illustrated, each second foot 246 includes an ankle portion 249 and an angled toe portion 251 coupled to the ankle portion 247.

The first foot 244, specifically the angled toe portion 247, is received in the first channel 230 (FIG. 20) formed on the perimeter 204 of the frame 202 and the second foot 246, specifically the angled toe portion 251 is received in the second channel 232 (FIG. 20) formed on the interior face 206 of the frame 202. Illustratively, the first channel 230 and the second channel 232 face substantially perpendicularly relative to each other, and the first foot 244 and the second foot 246 accordingly may face toward each other to facilitate receipt in the first channel 230 and the second channel 232, respectively. In other embodiments, the first foot 244 and the second foot 246 may have different arrangements depending on the arrangement of the first channel 230 and the second channel 232. The first foot 244 and the second foot 246 and/or the portions of the frame 202 adjacent to the first channel 230 and the second channel 232 may be sufficiently flexible to facilitate bending and receiving the feet 244, 246 in the channels 230, 232 when coupling the retainer 236 to the frame 202. In some embodiments, the retainer 236 is coupled to the frame 202 by camming, or rotating, the retainer 236 relative to the frame 202. More specifically, the first foot 244 is inserted into the first channel 230, then the second foot 246 is inserted into the second channel 232. In some embodiments, the second foot 246 is driven into the second channel 232 by applying additional force to the retainer 236 (e.g., by pressing on the retainer 236 by hand, striking the retainer 236 with a mallet, or the like).

During insertion of the frame 202 in the first insertion direction D1 (FIG. 20), one or more of the flex arms 240 of the retainer 236 (e.g., the longest flex arm 240 if a large gap is present between the frame 202 and the rough opening framing or all of the flex arms 240 if a small gap is present) bends or is deflected in a first flex direction. The insertion force, or force required to move the unit 200 in the first direction D1 may be, for example, 1 lb. or less, more than 1 lb, more than 10 lbs, or more than 15 lbs. Upon application of a force on the frame 202 in the second extraction direction D2, the flex arm 240 bends in a second flex direction to resist movement of the frame 202 in the second direction D2 (e.g., toward the interior side). The extraction or tipping force, or force required to move the unit 200 in the second direction D2 after seating may be greater than the insertion force. The extraction force may be, for example, 1 lb. or less, more than 1 lb, 10 lbs or more, at least 15 lbs, or 15 lbs or more. In some examples, the extraction force is 80 lbs or more, or approximately 88 lbs. Generally, a higher extraction or tipping force (e.g., as compared to the insertion force) helps ensure the fenestration unit 200 remains in place after being inserted into the rough opening to permit subsequent levelling and/or securement procedures.

Installation of the fenestration unit 200 in the rough opening may proceed in a substantially manner as the fenestration unit 100, as described above.

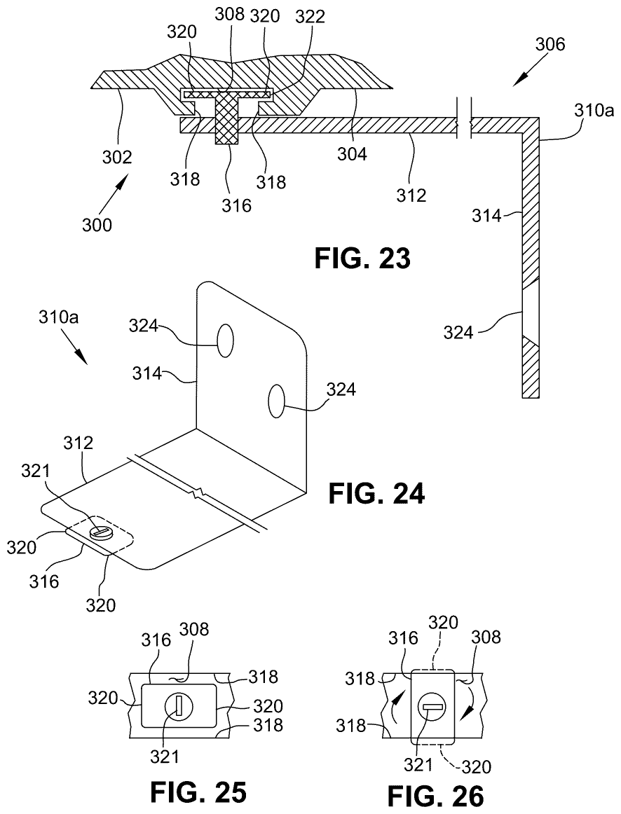

FIGS. 23-26 illustrate a fenestration unit 300, or components thereof, according to some embodiments. The components of the fenestration unit 300 may be substantially similar to the corresponding components and systems of the fenestration unit 200, except as described below. The fenestration unit 300 includes a frame 302 having an outer perimeter 304, and a mounting bracket system 306 couples to the frame 302 via a first channel 308, more specifically a “T-slot” or undercut channel 308, formed in the perimeter 304 of the frame 302. The mounting bracket system 306 includes one or more mounting brackets. The mounting brackets may each be substantially similar to one another and may be described cumulatively in association with a first one of the mounting brackets, an example of which (a first mounting bracket 310a) is depicted in FIGS. 23 and 24.

The first mounting bracket 310a generally includes a first leg 312 and a second leg 314. The first leg 312 and the second leg 314 may be integrally formed, or monolithically coupled, by fabricating the first mounting bracket 310a via sheet metal stamping and bending processes. In other embodiments, the first mounting bracket 310a may be fabricated using other materials and/or processes, and the first leg 312 and the second leg 314 may be coupled in other manners, such a via one or more fasteners (not shown). The first leg 312 of the first mounting bracket 310a includes a pivotable or rotatable interlocking cam 316 that is positionable in the channel 308 on the perimeter 304 of the frame 302. In an initial, or unlocked configuration shown in FIG. 25, the cam 316 is disposed apart from sidewalls 318 of the channel 308 and thereby insertable in the channel 308. The cam 316 is then pivoted to a locked configuration as shown in FIG. 26, and feet 320 of the cam 316 are positioned in an undercut portion 322 (FIG. 23) of the channel 308 and behind the sidewalls 318 of the channel 308. This action secures the cam 316, and thereby the mounting bracket 310, to the frame 302. In some embodiments and as illustrated, the cam 316 includes a slot 321 for receiving a tool (for example, a flat-head screwdriver; alternatively, a Phillips-head screwdriver, a star-head screwdriver driver, or the like) to facilitate pivoting the cam 316. In some embodiments, the cam 316 lacks a slot and is shaped or otherwise configured to be pivoted by a different tool, such as a wrench or the like.

With reference again to FIGS. 23 and 24, the second leg 314 of the first mounting bracket 310a extends approximately perpendicularly from the first leg 312 and outward relative to the frame 302. The second leg 314 is configured to abut an interior face of rough opening framing and thereby properly position the fenestration unit 300 in the rough opening. The second leg 314 includes one or more apertures 324 (illustratively, two apertures 324), and each aperture 324 is configured to receive a fastener (not shown) for securing the fenestration unit 300 to the rough opening framing. The apertures 324 may be recessed or countersunk to permit screw heads to be mounted flush.

Except for the actions for securing the cam 316 in the channel 308 of the frame 302, installation of the fenestration unit 300 in the rough opening may proceed in a substantially manner as the fenestration unit 100, as described above.

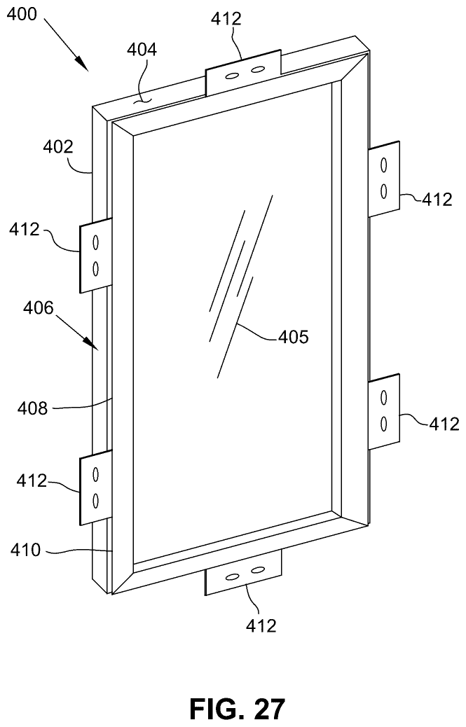

FIG. 27 illustrates a fenestration unit 400, according to some embodiments, where the view is a top-oriented perspective view from the interior side of a building or wall. FIG. 27 illustrates the fenestration unit 400 in an installing configuration in which the unit 400 is configured for positioning in a rough opening defined by rough opening framing (shown elsewhere) of the building or wall. The fenestration unit 400 is also configurable in an initial or pre-installation configuration (e.g., as initially received by an installer) and a final, installed configuration, or installation configuration (e.g., secured in the rough opening).

The fenestration unit 400 generally includes a frame 402 having an outer perimeter 404, a front or interior face (not shown), as well as a back or exterior face (not shown). The frame 402 may be constructed of vinyl, fiberglass, or other materials. The frame 402 supports a glazing unit 405, which may be any of a variety of configurations. As shown, the fenestration unit 400 is configured as a fixed window, but any of a variety of configurations (casement, single hung, double hung, awning or other) are also contemplated.

The fenestration unit 400 includes one or more installation features that facilitate installation of the fenestration unit 400 in the rough opening. For example, as shown, the fenestration unit 400 may include one or more of the following installation features: a mounting bracket system 406 (also described as an engagement system), a retention system including an installation stabilizer system (not shown) and a sill spacer system (not shown), and a weather seal system (not shown). The retention system and the weather seal system of the fenestration unit 400 may be substantially similar to the corresponding systems of any of the other fenestration units contemplated herein, such as the fenestration unit 100 or the fenestration unit 200. The mounting bracket system 406 may be as described below.

With continued reference to FIG. 27, the mounting bracket system 406 generally includes one or more mounting brackets 408 that are couplable to the frame 402. In some embodiments and as illustrated, the mounting bracket system 406 includes one mounting bracket 408. The mounting bracket 408 includes a base 410 that extends around the entire perimeter of the glazing unit 405. The base 410 detachably couples to the frame 402, for example, by including one or more legs (not shown) that are received in one or more channels of the frame 402, the channels being, for example, similar to the channel 146 formed on the perimeter 120 of the frame 110 (FIG. 4) or the accessory channel 232 formed on the interior face 206 of the frame 202 (FIG. 16). The base 410 couples to a plurality of second legs 412 configured to abut the rough opening framing and receive fasteners (not shown) for securing the fenestration unit 400 to the rough opening framing. In other embodiments, the mounting bracket system 406 includes a plurality of mounting brackets 408, and each bracket 408 extends along a portion of the perimeter of the glazing unit 405 and includes one or more second legs 412 configured to abut the rough opening framing and receive fasteners (not shown) for securing the fenestration unit 400 to the rough opening framing.

Alternatively, the second legs 412 may be part of or form a fin that is integrally coupled to the frame 402 at or near the interior side. In such embodiments, the fin may initially extend around additional portions or the entirety of the perimeter of the frame 402, and various portions of the fin may then be removed to form the second legs 412 at specific locations.

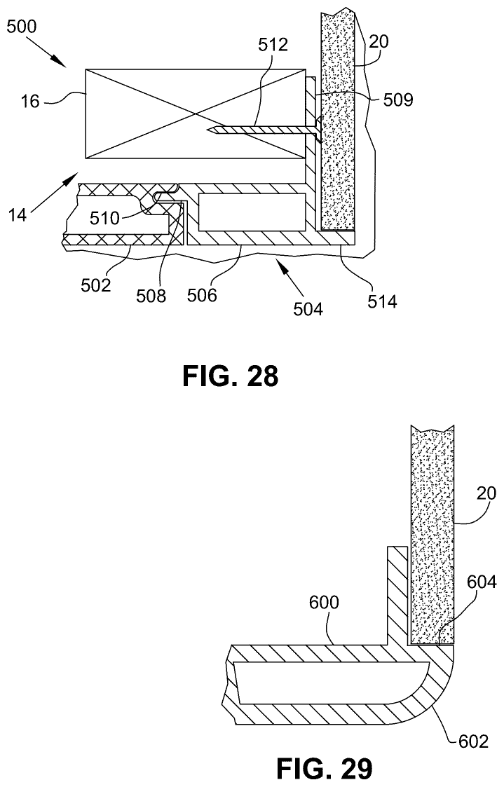

Fenestration units according to some embodiments of the present disclosure may be installed in newly constructed buildings or walls. Fenestration units according to some embodiments may alternatively be installed to retrofit previously constructed buildings or walls. FIG. 28 illustrates a fenestration unit 500, according to some embodiments, where the view is a side sectional view of the unit 500 and rough opening framing 16 and an interior wall covering 20 (e.g., drywall) of a building or wall. The fenestration unit 500 includes a frame 502 that may be substantially similar to any of the frames contemplated herein. The fenestration unit 500 also includes one or more installation features that facilitate installation of the fenestration unit 500 in the rough opening 14 of the building or wall. For example, the fenestration unit 500 may include one or more of the following installation features: a mounting bracket system 504 (also described as a frame or jamb extension), a retention system including an installation stabilizer system (not shown) and a sill spacer system (not shown), and a weather seal system (not shown). The retention system and the weather seal system of the fenestration unit 500 may be substantially similar to the corresponding systems of any of the other fenestration units contemplated herein, such as the fenestration unit 100 or the fenestration unit 200. The mounting bracket system 504 may be as described below.

With continued reference to FIG. 28, the jamb extension 504 generally includes one or more extenders 506 that are couplable to the frame 502. Each extender 506 may be functionally similar to any of the mounting brackets contemplated herein and may have various widths to accommodate different wall depths, such as 2×4 and 2×6 constructions. For example, each extender 506 includes a first leg 508 that is received in a channel 510 on the interior face of the frame 502 to detachably couple the extender 506 to the frame 502, and each extender 506 includes a second leg 509 that receives one or more fasteners 512 for securing the extender 506 to the rough opening framing 16. Additionally, each extender 506 includes a mounting flange 514 adjacent the second leg 509 for positioning, in a new constructed situation, the interior wall covering 20. In a retrofitting situation, the fasteners 512 may extend through both the interior wall covering 20 and the second leg 509 of each mounting bracket to secure the fenestration unit 500 to the rough opening framing 16.

FIG. 29 illustrates a jamb extension 600, according to some embodiments, where the view is a side sectional view of the extension 600 and an interior wall covering 20 (e.g., drywall) of a building or wall. The extension 600 may form part of the fenestration unit 500 (FIG. 28) instead of the extension 506. The extension 600 is substantially similar to the extension 506, except that the extension 600 includes a curved or rounded profile 602, to provide a “bullnose” aesthetic, opposite the mounting flange 604 and the interior wall covering 20.

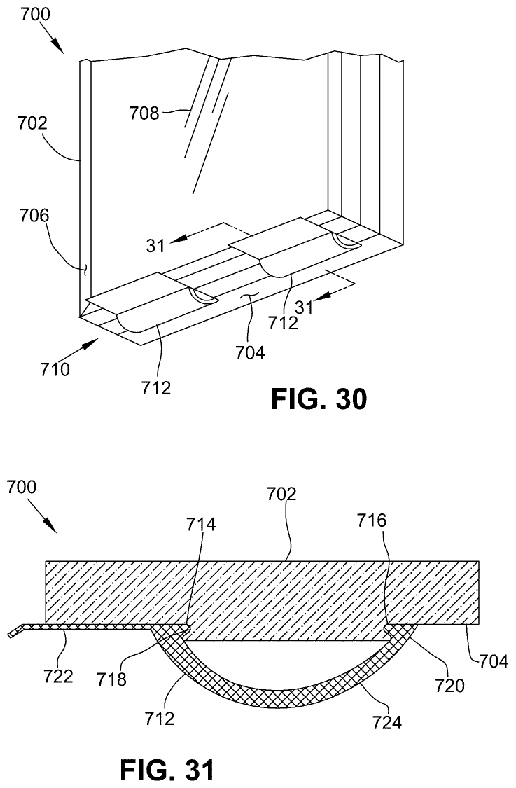

FIGS. 30 and 31 illustrate a fenestration unit 700, according to some embodiments, where FIG. 30 is a bottom-oriented perspective view from the interior side of a building or wall and FIG. 31 is a side sectional view. The fenestration unit 700 is illustrated in an installing configuration in which the unit 700 is configured for positioning in a rough opening defined by rough opening framing (shown elsewhere) of the building or wall. The fenestration unit 700 is also configurable in an initial or pre-installation configuration (e.g., as initially received by an installer) and a final, installed configuration, or installation configuration (e.g., secured in the rough opening).

The fenestration unit 700 generally includes a frame 702 having an outer perimeter 704, a front or interior face 706, as well as a back or exterior face (not shown). The frame 702 may be constructed of vinyl, fiberglass, or other materials. The frame 702 supports a glazing unit 708, which may be any of a variety of configurations. As shown, the fenestration unit 700 is configured as a fixed window, but any of a variety of configurations (casement, single hung, double hung, awning or other) are also contemplated.

The fenestration unit 700 includes one or more installation features that facilitate installation of the fenestration unit 700 in the rough opening. For example, as shown, the fenestration unit 700 may include one or more of the following installation features: a mounting bracket system (not shown, but may be substantially similar to any of the mounting bracket systems described herein, such as the mounting bracket system 128 or the mounting bracket system 212—also described as an engagement system), a retention system including an installation stabilizer system (not shown, but may be substantially similar to any of the stabilizer systems described herein, such as the stabilizer system 130 or the stabilizer system 214) and a sill spacer system 710, and a weather seal system (not shown, but may be substantially similar to any of the weather seal systems described herein, such as the weather seal system 134 or the weather seal system 218). The mounting bracket system, the installation stabilizer system, and the weather seal system of the fenestration unit 700 may be substantially similar to the corresponding systems of any of the other fenestration units contemplated herein, such as the fenestration unit 100 or the fenestration unit 200. The sill spacer system 710 may be as described below.

With continued reference to FIG. 30 and additional reference to FIG. 31, the sill spacer system 710 includes one or more sill spacers 712, such as a pair of sill spacers 712, that are selectively attachable to and detachable from the bottom of the frame 702. In some embodiments, the sill spacers 712 may be detached from the frame 702 in the pre-installation configuration (i.e., the sill spacers 712 may be initially provided to an installer or installers detached from the frame 702). In other embodiments, the sill spacers 712 may be coupled to the frame 702 in the pre-installation configuration (i.e., the sill spacers 712 may be initially provided to an installer or installers coupled to the frame 702).

In some embodiments, the sill spacer system 710 provides a convenient mechanism for positioning and leveling the fenestration unit 700 inside the rough opening (shown elsewhere). In some embodiments, the sill spacer system 710 facilitates centering the fenestration unit 700 within the rough opening by reducing friction between the frame 702 of the fenestration unit 700 and the rough opening framing as they move against each other. The sill spacer system 710 establishes a gap between the rough opening and the bottom of the frame 702 to make it easier for an installer to adjust the position of the fenestration unit 700 (e.g., insert a pry bar or other tool under the sill of the fenestration unit 700 for lifting and leveling). One or more shims, such as standard wood shims, can be slid under the sill spacer system 710 and/or otherwise under the fenestration unit 700 for leveling the fenestration unit 700 within the rough opening.

With specific reference to FIG. 31, each sill spacer 712 may include one or more legs (illustratively, a first leg 714 and a second leg 716) that are positioned in channels (illustratively, a first channel 718 and a second channel 720) formed on the perimeter 704 on the frame 702 for coupling the spacer 712 to the frame 702. More specifically, the legs 714 and 716 and channels 718 and 720 facilitate snap fitting the sill spacer 712 to the frame 702. Each sill spacer 712 may also include a handle 722 that facilitates attaching and detaching the spacer 712 from the frame 702. In some embodiments and as illustrated, the handle 722 extends in an interior direction and opposite the first leg 714. In some embodiments and as illustrated, the handle 722 is integrally formed with the remainder of the sill spacer 712. In some embodiments and as illustrated, each sill spacer 712 includes a rounded lower contact surface 724. Each sill spacer 712 may additionally include any of the features of the sill spacers described in U.S. Application No. 18/478, 189, filed Sep. 29, 2023, previously incorporated by reference.

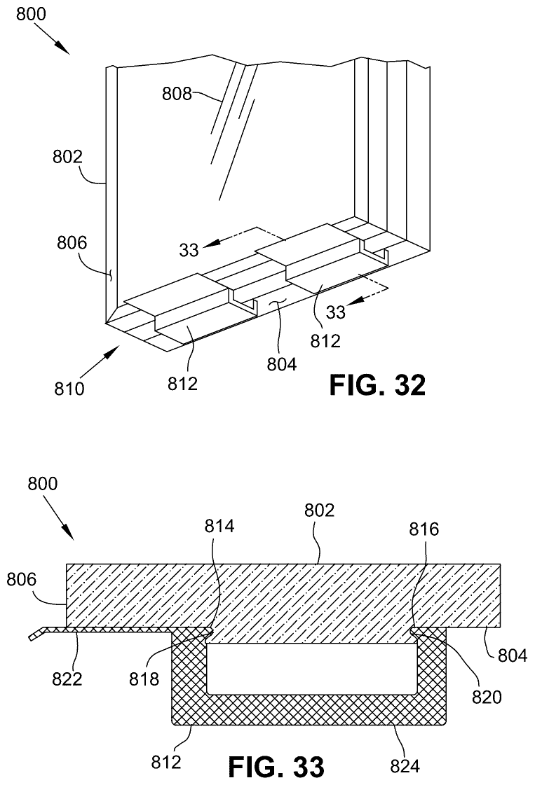

FIGS. 32 and 33 illustrate a fenestration unit 800, according to some embodiments, where FIG. 32 is a bottom-oriented perspective view from the interior side of a building or wall and FIG. 33 is a side sectional view. The fenestration unit 800 is illustrated in an installing configuration in which the unit 800 is configured for positioning in a rough opening defined by rough opening framing (shown elsewhere) of the building or wall. The fenestration unit 800 is also configurable in an initial or pre-installation configuration (e.g., as initially received by an installer) and a final, installed configuration, or installation configuration (e.g., secured in the rough opening).

The fenestration unit 800 generally includes a frame 802 having an outer perimeter 804, a front or interior face 806, as well as a back or exterior face (not shown). The frame 802 may be constructed of vinyl, fiberglass, or other materials. The frame 802 supports a glazing unit 808, which may be any of a variety of configurations. As shown, the fenestration unit 800 is configured as a fixed window, but any of a variety of configurations (casement, single hung, double hung, awning or other) are also contemplated.

The fenestration unit 800 includes one or more installation features that facilitate installation of the fenestration unit 800 in the rough opening. For example, as shown, the fenestration unit 800 may include one or more of the following installation features: a mounting bracket system (not shown, but may be substantially similar to any of the mounting bracket systems described herein, such as the mounting bracket system 128 or the mounting bracket system 212—also described as an engagement system), a retention system including an installation stabilizer system (not shown, but may be substantially similar to any of the stabilizer systems described herein, such as the stabilizer system 130 or the stabilizer system 214) and a sill spacer system 810, and a weather seal system (not shown, but may be substantially similar to any of the weather seal systems described herein, such as the weather seal system 134 or the weather seal system 218). The mounting bracket system, the installation stabilizer system, and the weather seal system of the fenestration unit 800 may be substantially similar to the corresponding systems of any of the other fenestration units contemplated herein, such as the fenestration unit 100 or the fenestration unit 200. The sill spacer system 810 may be as described below.

With continued reference to FIG. 32 and additional reference to FIG. 33, the sill spacer system 810 includes one or more sill spacers 812, such as a pair of sill spacers 812, that are selectively attachable to and detachable from the bottom of the frame 802. In some embodiments, the sill spacers 812 may be detached from the frame 802 in the pre-installation configuration (i.e., the sill spacers 812 may be initially provided to an installer or installers detached from the frame 802). In other embodiments, the sill spacers 812 may be coupled to the frame 802 in the pre-installation configuration (i.e., the sill spacers 812 may be initially provided to an installer or installers coupled to the frame 802).

In some embodiments, the sill spacer system 810 provides a convenient mechanism for positioning and leveling the fenestration unit 800 inside the rough opening (shown elsewhere). In some embodiments, the sill spacer system 810 facilitates centering the fenestration unit 800 within the rough opening by reducing friction between the frame 802 of the fenestration unit 800 and the rough opening framing as they move against each other. The sill spacer system 810 establishes a gap between the rough opening and the bottom of the frame 802 to make it easier for an installer to adjust the position of the fenestration unit 800 (e.g., insert a pry bar or other tool under the sill of the fenestration unit 800 for lifting and leveling). One or more shims, such as standard wood shims, can be slid under the sill spacer system 810 and/or otherwise under the fenestration unit 800 for leveling the fenestration unit 800 within the rough opening.

With specific reference to FIG. 33, each sill spacer 812 may include one or more legs (illustratively, a first leg 814 and a second leg 816) that are positioned in channels (illustratively, a first channel 818 and a second channel 820) formed on the perimeter 804 on the frame 802 for coupling the spacer 812 to the frame 802. Each sill spacer 812 may also include a handle 822 that facilitates attaching and detaching the spacer 812 from the frame 802. In some embodiments and as illustrated, each sill spacer 812 includes a flat lower contact surface 824 or is substantially rectangular. Each sill spacer 812 may additionally include any of the features of the sill spacers described in U.S. Application No. 18/478, 189, filed Sep. 29, 2023, previously incorporated by reference.

In other embodiments, the first channel 818 and the second channel 820 are recessed in the frame 802, and a force pushing the frame 802 toward the spacer(s) 812 pushes the legs 814, 816 of the spacer(s) 812 into the channels 818, 820, respectively, in contrast to potentially moving the legs 814, 816 apart. This arrangement provides further positive engagement of the spacer(s) 812 for relatively heavy units and nevertheless permits easy insertion and removal of the spacer(s) 812 from the frame 802.

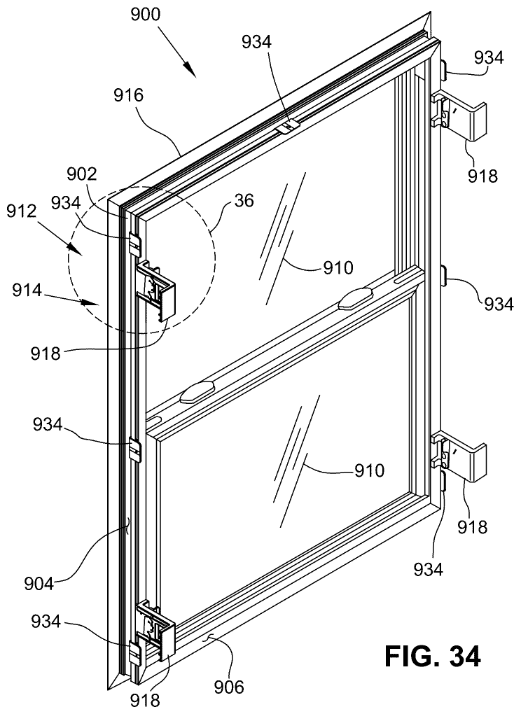

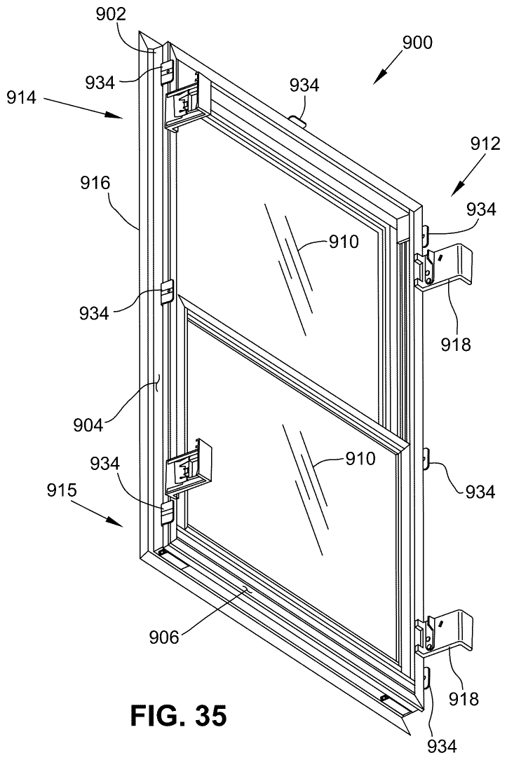

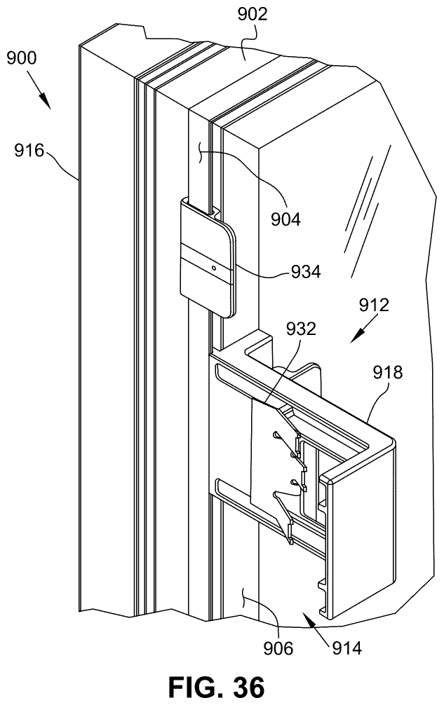

FIGS. 34-36 illustrate a fenestration unit 900, according to some embodiments, where FIGS. 34 and 35 are perspective views from the interior side of a building or wall and FIG. 36 is a detail side view. FIGS. 34-36 illustrate the fenestration unit 900 in an installed configuration, or installation configuration (e.g., secured in a rough opening defined by rough opening framing of a building or a wall—rough opening shown elsewhere). The fenestration unit 900 is also configurable in an initial or pre-installation configuration (e.g., as initially received by an installer) and an installing configuration in which the unit 900 is configured for positioning in the rough opening.

The fenestration unit 900 generally includes a frame 902 having an outer perimeter 904, a front or interior face 906, as well as a back or exterior face (not shown). As illustrated, the frame 902 may be a fiberglass frame design. However, vinyl, wood, or other materials may be implemented for the frame 902. The frame 902 supports one or more glazing units 910 (FIGS. 34 and 35), which may be any of a variety of configurations. As shown, the fenestration unit 900 is configured as a double hung window, but any of a variety of configurations (fixed, single hung, casement, awning or other) are also contemplated.

As shown in FIGS. 34-36, the fenestration unit 900 includes one or more installation features that facilitate installation of the fenestration unit 900 in the rough opening. For example, as shown, the fenestration unit 900 may include one or more of the following installation features: a mounting bracket system 912 (also described as an engagement system), a retention system including an installation stabilizer system 914 and a sill spacer system 915 (FIG. 35), a weather seal system 916. The sill spacer system 915 and the weather seal system 916 of the fenestration unit 900 may be substantially similar to the corresponding systems of any of the other fenestration units contemplated herein, such as the fenestration unit 100 or the fenestration unit 200. The mounting bracket system 912 and the stabilizer system 914 may be as described below.

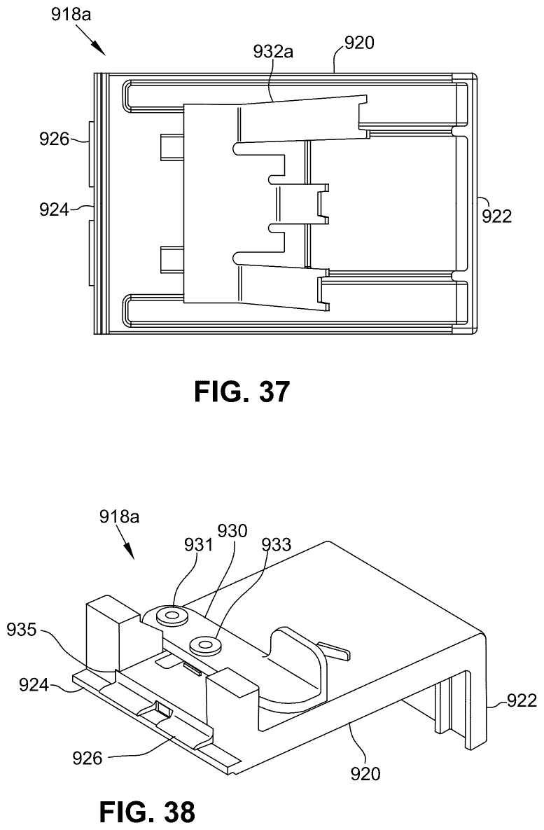

With continued reference to FIGS. 34-36, the mounting bracket system 912 generally includes a plurality of mounting brackets 918, also referred to as gaging brackets 918, that are couplable to the outer perimeter 904 of the frame 902 and gauged to the interior surface of the rough opening, detachable from the frame 902 after mounting the unit 900 in the rough opening, and is optionally reusable with the same, or a different fenestration unit. In some embodiments, the mounting brackets 918 are detached from the frame 902 in the pre-installation configuration. In other embodiments, the mounting brackets 918 are coupled to the frame 902 in the pre-installation configuration. The mounting brackets 918 may each be substantially similar to one another and may be described cumulatively in association with a first one of the mounting brackets 918, an example of which (a first mounting bracket 918a) is depicted in FIGS. 37-40.

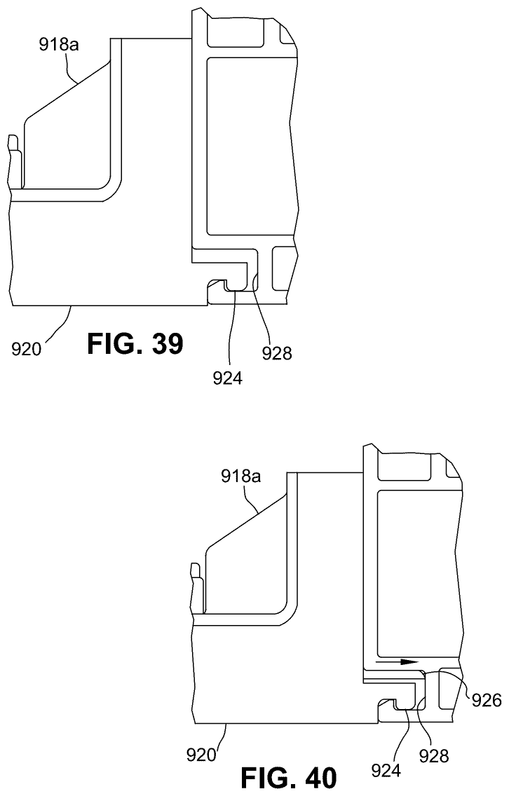

As shown in FIGS. 37-40, the first mounting bracket 918a generally includes a first leg 920 and a second leg 922. The first leg 920 and the second leg 922 may be integrally formed, or monolithically coupled, via an injection molding process. In other embodiments, the first leg 920 and the second leg 922 may be manufactured using a different process, and the first leg 920 and the second leg 922 may be coupled in other manners, such a via one or more fasteners (not shown). In some embodiments, the first leg 920 and the second leg 922 may be relatively movable/adjustable to facilitate use of the first mounting bracket 918a when installing fenestration units in walls of various depths (for example, from about 3 inches to 12 inches). The first leg 920 of the first mounting bracket 918a includes one or more feet, illustratively a first or stationary foot 924 and a second or movable foot 926 that are generally disposed apart from the second leg 922. The first foot 924 and the second foot 926 are received in a channel formed on the frame 902 (FIG. 36) to secure the first mounting bracket 918a to the frame 902. More specifically and referring to FIGS. 39 and 40, the first foot 924 is positioned in an interior accessory channel 928 of the frame 902 by abutting the first mounting bracket 918a against the frame 902, and then the second foot 926 is moved from a retracted configuration (FIG. 39) to an extended configuration (FIG. 40) and into the channel 928. The feet 924, 926 thereby substantially occupy the entire cross-sectional area of the channel 928 and inhibit unintended detachment of the first mounting bracket 918a from the frame 902.

With specific reference to FIG. 38, in some embodiments the first mounting bracket 918a includes an actuator, more specifically a pivotable lever 930, for moving the second foot 926 from the retracted configuration to the extended configuration and vice versa. The lever 930 pivotably couples to the first leg 920 via a first pivot 931, and the lever 930 pivotably couples to the second leg 926 via a second pivot 933. The actuator moves the second foot 926 in a track 935 formed on the first leg 920. In other embodiments, the first mounting bracket 918a includes other features for moving the second foot 926 from the retracted configuration to the extended configuration and vice versa.

With reference again to FIGS. 37 and 38, the second leg 922 of the first mounting bracket 918a extends approximately perpendicularly from the first leg 920. The second leg 922 is configured to abut the interior face of the rough opening framing and thereby properly position the fenestration unit 900 in the rough opening. In some embodiments and as illustrated, the second leg 922 lacks apertures for receiving fasteners and securing the fenestration unit 900 to the rough opening framing. In other embodiments, the second leg 922 includes one or more apertures (not shown) for receiving fasteners and securing the fenestration unit 900 to the rough opening framing.

With reference to FIGS. 36 and 37, the installation stabilizer system 914 includes one or more retainers 932, also described as stabilizer clips 932. In some embodiments and as illustrated, the installation stabilizer system 914 includes one or more retainers 932 each coupled to one of the mounting brackets 918, including the first mounting bracket 918a. The retainers 932 may each be substantially similar to one another and may be described cumulatively in association with a first one of the retainers 932, an example of which (a first retainer 932a) is depicted in FIG. 37. Generally, the retainer 932a is configured to permit insertion of the frame 902 within the rough opening in a first insertion direction and resist extraction of the frame 902 from the rough opening in a second extraction direction. The retainer 932a may be substantially similar to any of the other retainers contemplated herein, including those of the fenestration unit 100 and the fenestration unit 200.

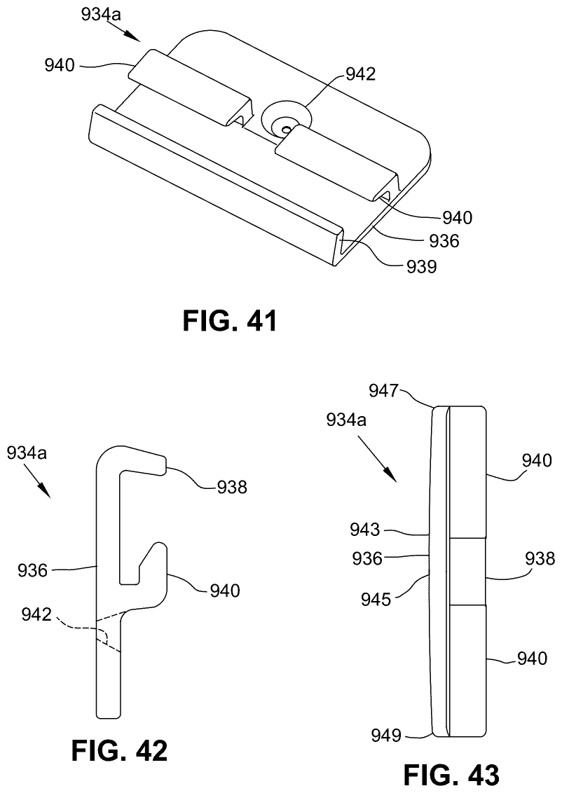

With reference again to FIGS. 34-36, the mounting bracket system 912 also includes one or more coupling brackets 934 for securing the fenestration unit 900 to the rough opening framing. In some embodiments, the coupling brackets 934 are detached from the frame 902 (e.g., being supplied in associated packaging and/or as a kit including a plurality of differently sized brackets) in the pre-installation configuration. In other embodiments, the coupling brackets 934 are coupled to the frame 902 in the pre-installation configuration. Illustratively, the mounting bracket system 912 includes seven coupling brackets 934, with three coupling brackets 934 disposed on the left side of the frame 902, three coupling brackets 934 disposed on the right side of the frame 902, and one coupling bracket 934 disposed on the top of the frame 902. The coupling brackets 934 may each be substantially similar to one another and may be described cumulatively in association with a first one of the coupling brackets 934, an example of which (a first coupling bracket 934a) is depicted in FIGS. 41 and 42.

As shown in FIGS. 41-44, the first coupling bracket 934a generally includes a base 936, one or more first feet 938 (illustratively, one first foot 938), and one or more second feet 940 (illustratively, two second feet 940). The base 936, the first foot 938, and the second feet 940 may be integrally formed, or monolithically coupled, by fabricating the first coupling bracket 934a via sheet metal stamping and bending processes. In other embodiments, the first coupling bracket 934a may be fabricated using other materials and/or processes. The first foot 938 and the second feet 940 are received in channels formed on the frame 902 to secure the first coupling bracket 934a to the frame 902. More specifically, the first foot 938 is received in an installation fin channel (not shown) formed on the perimeter 904 of the frame 902, and the second feet 940 is received in the interior accessory channel 928 of the frame 902. Illustratively, the first foot 938 and the second feet 940 face toward each other to facilitate receipt in the installation fin channel and the interior accessory channel 928, respectively. In other embodiments, the first foot 938 and the second feet 940 may have different arrangements. The first foot 938 and the second feet 940 and/or the portions of the frame 902 adjacent to the channels may be sufficiently flexible to facilitate bending and receiving the feet 938, 940 in the channels when coupling the coupling bracket 934a to the frame 902. In some embodiments, the first coupling bracket 934a is coupled to the frame 902 by camming, or rotating, the first coupling bracket 934a relative to the frame 902. More specifically, the second foot 940 is inserted into a channel of the frame 902, and then the first foot 938 is inserted into a channel of the frame 902.

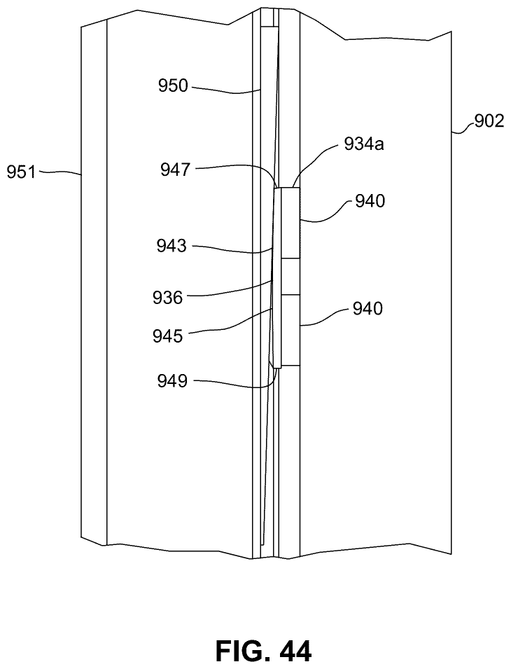

In some embodiments, the first foot 938 is driven into the channel by applying additional force to the first coupling bracket 934a (e.g., by pressing on the first coupling bracket 934a by hand, striking the first coupling bracket 934a with a mallet, or the like). The base 936 of the coupling bracket 934a includes one or more apertures 942 (illustratively, countersink apertures) for receiving fasteners and thereby securing the fenestration unit 900 to the rough opening framing. In some embodiments, the aperture 942 acts as a centering guide for the coupling bracket 934a, as a means to easily locate the center of the aperture 942 and hold the bracket 934a stationary when driving fasteners through the aperture 942. In some embodiments, the outer surface 943 of the coupling bracket 934a (that is, the surface of the base 936 opposite the first foot 938 and the second feet 940) includes a double taper. Stated another way, a central portion 945 of the outer surface 943 is disposed further from the first foot 938 and the second feet 940 than an upper end 947 and a lower end 949 of the outer surface 943. In certain embodiments, the double taper advantageously permits a shim 950 to be inserted between the bracket 934a and the rough opening framing 951 from either the upper end 947 (as shown in FIG. 44) or the lower end 949. If a shim is installed from the upper end 947 (as shown in FIG. 44), gravity advantageously facilitates moving the shim between the bracket 934a and the rough opening framing. Relatedly, the double taper advantageously permits use of full-length shims; in contrast, horizontally-inserted shims have a limited insertion depth based on the depth of the unit (for example, about 2 inches) or are shortened to avoid interfering with other components. Relatedly, the double taper advantageously permits the shim to provide even pressure over half of the outer surface 943 of the bracket 934a, in contrast to a line load, and rotating of the bracket 934a when a fastener is driven into the aperture 942. Further relatedly, the double taper also permits the bracket 934a to act as a universal piece that can be used on either jamb (that is, the bracket 934a is not specifically right-handed or left-handed), and gravity advantageously facilitates positioning shims in both situations and orientations. Even further relatedly, the double taper advantageously reduces installation time, facilitates easy and more consistent adjustments, and reduces or eliminates rotation of the bracket 934a and unit movement when the fastener is driven through the aperture 942.

Advantageously, the coupling brackets 934 may have the same sizes and/or arrangements for fenestration units and rough openings of various sizes.

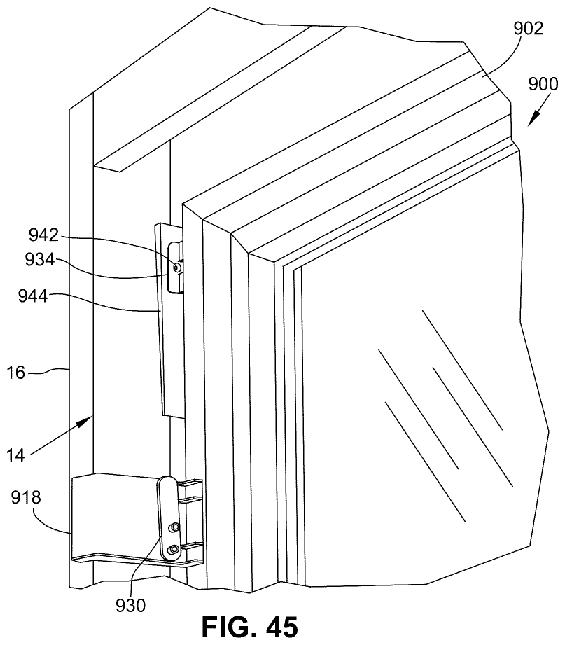

Installation of the fenestration unit 900 in the rough opening may proceed in a substantially manner as the fenestration unit 100, as described above, except that, and as shown in FIG. 45, (A) shims 944, such as standard wood shims, can be slid between the coupling brackets 934 and the rough opening framing 16 to center and tighten the fenestration unit 900 within the rough opening 14; (B) fasteners are driven through the apertures 942 of the coupling brackets 934, through the shims 944, and into the rough opening framing 16 to secure the fenestration unit 900 to the rough opening framing 16; and (C) the mounting brackets 918 may then be detached from the frame 902, for example, by using the actuators 930 to move the second legs 922 to the retracted position (FIG. 39).

Various advantages may be achieved according to the foregoing example systems and methods. The various examples may be one or more of: more efficient (e.g., cycle time reduced by 50% or more); easier to learn; easier to remember; easier to train; may be less physically demanding (e.g., fenestration units are not set from the exterior side which could be on uneven ground or require a ladder); fenestration units are unable to fall out toward exterior during installation; can be installed by a single person from the interior of the building or wall; interior and exterior installation tasks do not need to be done simultaneously; improved fenestration unit install quality and fenestration unit performance following installation; delivers an installation method that is unique to the industry and offers many benefits for the installer; faster cycle times; improved performance (water and air infiltration); adapts to wall depth variation; simplifies casing installation for finish carpenters; separates interior and exterior work so they can be done “independently”.

The invention of this application has been described above both generically and with regard to specific embodiments. It will be apparent to those skilled in the art that various modifications and variations can be made in the embodiments without departing from the scope of the disclosure. Thus, it is intended that the embodiments cover the modifications and variations of this invention provided they come within the scope of the appended claims and their equivalents.

What is claimed is:

1. A fenestration unit configured for installation in a rough opening in a structure defined by rough opening framing, the rough opening framing having an interior face and an exterior face opposite the interior face, the fenestration unit comprising:
a frame comprising a channel; and
a plurality of mounting brackets configured to be secured to the frame, the plurality of mounting brackets comprising a first mounting bracket, the first mounting bracket comprising:
a first leg comprising a foot configured to be received in the channel to secure the first mounting bracket to the frame; and
a second leg coupled to the first leg, the second leg angularly offset from the first leg and configured to abut the interior face of the rough opening framing.

2. The fenestration unit of claim 1, wherein the frame further comprises a sidewall defining the channel, the sidewall comprising a slot, and the foot being received in the slot.

3. The fenestration unit of claim 1, wherein the foot comprises an ankle portion coupled to an angled toe portion.

4. The fenestration unit of claim 1, further comprising an installation stabilizer system coupled to the frame and operable to exert a retention force on the rough opening framing to maintain positive engagement of the fenestration unit with the rough opening framing and resist extraction of the fenestration unit from the rough opening upon insertion of the fenestration unit in the rough opening.

5. The fenestration unit of claim 1, wherein the first leg is integrally formed with the second leg.

6. The fenestration unit of claim 1, wherein the frame further comprises a sill, and further comprising a sill spacer coupled to the sill and configured to abut the rough opening framing.

7. The fenestration unit of claim 1, further comprising a fin assembly coupled to the frame, the fin assembly configured to transition from a first, stowed configuration in which the fin assembly projects in a direction of a front of the frame and a second, deployed configuration in which the fin assembly projects outward relative to the frame.

8. The fenestration unit of claim 1, wherein the frame further comprises an exterior surface, an interior surface opposite the exterior surface, and a perimeter between the exterior surface and the interior surface, the channel being disposed on the perimeter.

9. The fenestration unit of claim 1, wherein the frame further comprises an exterior surface, an interior surface opposite the exterior surface, and a perimeter between the exterior surface and the interior surface, the channel being disposed on the interior surface.

10. The fenestration unit of claim 9, wherein the mounting bracket further comprises an installation stabilizer system operable to exert a retention force on the rough opening framing to maintain positive engagement of the fenestration unit with the rough opening framing and resist extraction of the fenestration unit from the rough opening upon insertion of the fenestration unit in the rough opening.

11. A method of installing a fenestration unit in a rough opening in a structure defined by rough opening framing, the rough opening framing having an interior face and an exterior face opposite the interior face, the method comprising:
coupling a first mounting bracket to a frame of the fenestration unit by positioning a foot of a first leg of the first mounting bracket in a channel of the frame;
seating the fenestration unit in the rough opening by together translating the frame and the first mounting bracket in an exterior direction within the rough opening until a second leg of the first mounting bracket angularly offset from the first leg is abutted against the interior face of the rough opening framing; and
securing the fenestration unit to the rough opening framing.

12. The method of claim 11, wherein the frame further comprises a sidewall defining the channel, the sidewall comprising a slot, and positioning the foot of the first mounting bracket in the channel comprises positioning the foot in the slot.

13. The method of claim 11, wherein seating the fenestration unit in the rough opening further comprises abutting an installation stabilizer system coupled to the fenestration unit against the rough opening framing such that the installation stabilizer system exerts a retention force on the rough opening framing to retain the fenestration unit in the rough opening and prevent tipping of the fenestration unit in an interior direction opposite the exterior direction.

14. The method of claim 11, wherein seating the fenestration unit in the rough opening further comprises abutting a sill spacer coupled to a bottom of the frame against the rough opening framing.

15. The method of claim 11, further comprising deploying a fin assembly coupled to the frame from a first, stowed configuration in which the fin assembly projects in the exterior direction to a second, deployed configuration in which the fin assembly projects outward relative to the frame.

16. The method of claim 11, wherein the second leg comprises an aperture, and wherein securing the fenestration unit to the rough opening framing comprises inserting a fastener in the aperture.

17. The method of claim 11, wherein the frame further comprises an exterior surface, an interior surface opposite the exterior surface, and a perimeter between the exterior surface and the interior surface, the channel being disposed on the interior surface.

18. The method of claim 11, wherein the frame further comprises an exterior surface, an interior surface opposite the exterior surface, and a perimeter between the exterior surface and the interior surface, the channel being disposed on the perimeter.

19. The method of claim 11, wherein seating the fenestration unit in the rough opening further comprises abutting an installation stabilizer system coupled to the first mounting bracket against the rough opening framing such that the installation stabilizer system exerts a retention force on the rough opening framing to retain the fenestration unit in the rough opening and prevent tipping of the fenestration unit in an interior direction opposite the exterior direction.

20. The method of claim 11, further comprising, after seating the fenestration unit in the rough opening, abutting the first mounting bracket against the interior face of the rough opening framing, and securing the fenestration unit to the rough opening framing, detaching the first mounting bracket from the frame.
